(19) United States
(12) Patent Application Publication
(10) Pub. No.: US 2019/0283616 A1
(43) Pub. Date: Sep. 19, 2019

(54) SYSTEMS AND METHODS FOR PAIRING IN WIRELESS ENERGY TRANSFER NETWORKS

(71) Applicant: Elix Wireless Charging Systems Inc., Vancouver (CA)

(72) Inventors: Allen UPWARD, Vancouver (CA); Arash AHMADI, West Vancouver (CA)

(21) Appl. No.: 16/358,612

(22) Filed: Mar. 19, 2019

Related U.S. Application Data
(60) Provisional application No. 62/644,788, filed on Mar. 19, 2018.

(51) Int. Cl. B60L 53/126; B60L 53/30; B60L 53/36; H04B 5/00; H02J 50/10

(52) U.S. Cl. CPC B60L 53/126; B60L 53/305; H02J 50/10; H04B 5/0037; B60L 53/36

(57) ABSTRACT

Methods and systems are provided for communication between a wireless charging station and an electric vehicle to facilitate wireless power transfer from the charging station to the vehicle. The vehicle comprises a near-field proximity transmitter circuit for transmitting a proximity signal to a near-field proximity receiver circuit on the charging station. While the received proximity signal is indicative of the vehicle being insufficiently proximate to the charging station for efficient power transfer, the charging station outputs instructions to move the vehicle towards the charging station. When the received proximity signal at the charging station is indicative of the vehicle being sufficiently proximate to the charging station, the charging station may transmit wireless power to a wireless power receiver on vehicle.

### REFERENCE TO RELATED APPLICATIONS

This application claims the benefit of the priority from, and the benefit under 35 USC 119(e) of, U.S. application No. 62/644,788 filed 19 Mar. 2018 and entitled, SYSTEMS AND METHODS FOR PAIRING IN WIRELESS ENERGY TRANSFER NETWORKS.

### TECHNICAL FIELD

This application pertains to methods and systems for pairing in wireless energy transfer networks. Particular embodiments pertain to pairing an electric vehicle with a wireless charging station.

### BACKGROUND

In a wireless energy transfer network, there may be a multitude of wireless energy providers and a plurality of wireless energy consumers. Specifically, in the context of wirelessly charging of electric vehicles, there may be a plurality of wireless charging stations (the wireless energy providers) situated in a parking garage or any other suitable charging location and a plurality of electric vehicles to be charged (the wireless energy consumers).

Power can be wirelessly conveyed from one place to another using the Faraday effect, whereby a changing magnetic field causes an electrical current to flow in an electrically isolated secondary circuit. A form of wireless power transfer (WPT) currently in use involves magnetic inductive charging. One form of magnetic inductive charging is shown in WPT system 10 of FIG. 1. The FIG. 1 WPT system 10 comprises two coils 12, 14 in close proximity but separated by a gap (typically an air gap) 16. One coil (transmitter coil) 12 of WPT system 10 acts as a wireless power transmitter and the other coil (receiver coil) 14 acts as the receiver of wireless power. A time-varying current is caused to flow in transmitter coil 12 by suitable electronic circuitry (not shown). The current flow in transmitter coil 12 produces a time-varying magnetic field (shown as flux lines in FIG. 1). This time-varying magnetic field induces current in the nearby receiver coil 14 (Faraday's law), which can then be used to charge various devices (not shown), such as charge storage devices (e.g. batteries or the like), electrically connected to receiver coil 14 by suitable electronic circuitry (not shown).

In PCT application No. PCT/CA2010/000252 (published under WO/2010/096917), a magneto-dynamic coupling (MDC) technology has been described to provide a number of viable WPT systems that can be used to charge, by way of non-limiting example, batteries generally, electric (e.g. battery operated) vehicles, auxiliary batteries, electric (e.g. battery operated) buses, golf carts, delivery vehicles, boats, drones, trucks and/or the like. FIG. 2 schematically depicts a WPT system 20 incorporating MDC technology of the type described in PCT/CA2010/000252. WPT system 20 comprises a wireless magnetic power transmitter 22 and a wireless magnetic power receiver 24 separated by a gap (typically, an air gap) 26. In MDC-based WPT system 20 of the FIG. 2 embodiment, power is transferred via moveable (e.g. rotational) magnetic coupling rather than via direct magnetic induction. In the exemplary FIG. 2 MDC-based WPT system 20, transmitter 22 comprises a permanent magnet 22A and receiver 24 comprises a permanent magnet 24A. Transmitter magnet 22A and receiver magnet 24A are movably coupled to one another to wirelessly transfer power therebetween. Specifically, transmitter magnet 22A is rotated (and/or pivoted) about axis 28—e.g. by a suitable mechanical and/or electromechanical system (not shown). The magnetically coupled permanent magnets 22A, 24A interact with one another (magnetic poles represented by an arrow with notations of “N” for north and “S” for south in FIG. 2), such that movement of transmitter magnet 22A about axis 28 causes corresponding movement (e.g. rotation and/or pivotal movement) of receiver magnet 24A about axis 27. The motion of permanent magnets 22A, 24A may be periodic. The time-varying magnetic fields generated by rotating/pivoting magnets 22A, 24A of MDC-based WPT system 20 typically have a lower frequency compared to WPT systems based on magnetic induction.

In a wireless charging scenario, such as, without limitation, when wireless charging a wireless vehicle, it can be desirable to establish communication between a controller associated with the wireless energy provider (e.g. the charging station) and a controller associated with the wireless energy consumer (e.g. the electric vehicle). Such communication can, for example, be used to communicate vehicle and/or battery-specific parameters from a vehicle to a charging station. Such communication can, for example, be used to control charging parameters (e.g. the rate of charge transfer, the total amount of charge transfer and/or the like), to monitor safety parameters, such as temperature and/or the like, to facilitate billing and/or any of a variety of other tasks. There is a general desire for such communication between the wireless energy provider (e.g. the charging station) and a controller associated with the wireless energy consumer (e.g. the electric vehicle) to be wireless, since the WPT is itself wireless.

Some wireless communication protocols (such as Bluetooth™, Zigbee™ and/or the like) involve so-called “pairing” between pairs of communication devices. Where there are a plurality of wireless energy providers (e.g. charging stations) and a plurality of wireless energy consumers (e.g. electric vehicles) in relatively close proximity to one another, it can be challenging to pair a particular wireless energy provider with a particular wireless energy consumer, because a wireless energy provider may observe a number of wireless energy consumers within its wireless communication range and, similarly, a wireless energy consumer may observe a number of wireless energy providers within its wireless communication range. There is a general desire for improved techniques for pairing wireless energy providers with wireless energy consumers. While this desire is not limited to any specific circumstances, this desire can be particularly acute in situations where there are a plurality of wireless energy providers (e.g. charging stations) and a plurality of wireless energy consumers (e.g. electric vehicles) in close proximity to one another.

There may be a general desire to position the wireless energy provider and wireless energy consumer relative to one another to efficiently and safely transfer power. For example, in the case where the wireless energy provider is a vehicle charging station and the wireless energy consumer is an electric vehicle, there may be a general desire to position wireless power receiver in the electric vehicle relative to the wireless power transmitter in a vehicle charging station to efficiently and safely transfer power.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for communication between a wireless charging station and a vehicle to facilitate wireless power transfer from a wireless power transmitter of the charging station to a wireless power receiver of the vehicle. The method comprises providing a wireless charging station comprising a near-field proximity receiver circuit on the wireless charging station. The near-field proximity receiver circuit receives a proximity signal sent wirelessly from a near-field proximity transmitter circuit of the vehicle. While the received proximity signal is indicative of the vehicle being insufficiently proximate to the charging station for efficient power transfer, instructions are output, in response to the received proximity signal, to move the vehicle to, by such movement, reduce a distance between the vehicle and the charging station. When the received proximity signal is indicative of the vehicle being sufficiently proximate to the charging station for efficient power transfer, power is wirelessly transmitted from the wireless power transmitter of the charging station to the wireless power receiver of the vehicle.

A second wireless communication link may be established between a wireless radio transceiver of the charging station and a wireless radio transceiver of the vehicle. An address of the wireless radio transceiver of the vehicle, sent by the near-field proximity transmitter circuit of the vehicle, may be received at the near-field proximity receiver circuit. The method may comprise communicating between a controller of the charging station and a controller of the vehicle using the second wireless communication link during wireless transmission of power. The second wireless communication link may be established prior to wirelessly transmitting power.

A pulse of power may be wirelessly transmitted from the wireless power transmitter of the charging station to the wireless power receiver prior to receiving, at the proximity receiver circuit, the address of the wireless radio transceiver of the vehicle sent by the proximity transmitter circuit. The pulse of power may be wirelessly transmitted in response to determining that the received proximity signal is indicative of the vehicle being sufficiently proximate to the charging station for efficient power transfer. After receiving the address of the wireless radio transceiver of the vehicle at the proximity receiver circuit, a pairing may be established between the wireless radio transceiver of the charging station and the wireless radio transceiver of the vehicle to thereby establish the second wireless communication link.

The method may comprise receiving, at the near-field proximity receiver circuit, the proximity signal sent wirelessly from the near-field proximity transmitter circuit of the vehicle during wireless transmission of power. The proximity signal and the address of the wireless radio transceiver of the vehicle received at the proximity receiver circuit may be time division multiplexed. The output instructions to move the vehicle may be perceptible to a human operator of the vehicle. The output instructions to move the vehicle may be suitable for a driving controller of an autonomous vehicle. The output instructions suitable for the driving controller of the autonomous vehicle may be output over the second wireless communication link.

The second wireless communication link may comprise a far-field wireless communication link. The wireless charging station may comprise a near-field wireless transmitter. The method may comprise transmitting an address of the wireless radio transceiver of the charging station from the near-field wireless transmitter to a near-field wireless receiver of the vehicle. The near-field wireless transmitter and the near-field proximity receiver circuit of the charging station may be integrated into a charging station transceiver. The near-field wireless transmitter and the near-field proximity receiver circuit of the charging station may be separately embodied. The method may comprise determining when the received proximity signal is indicative of the vehicle being sufficiently proximate to the charging station for efficient power transfer by comparing the strength of the received proximity signal to a strength threshold.

Another aspect of the invention provides a wireless charging station for wireless charging station for wireless power transfer from the wireless charging station to a wireless power receiver of a vehicle. The wireless charging station comprises a near-field proximity receiver circuit, a wireless power transmitter, and a controller operatively connected to the near-field proximity receiver circuit and to the wireless power transmitter. The near-field proximity receiver circuit is operative to receive a near-field proximity signal from a near-field proximity transmitter of the vehicle. The controller is configured to output instructions, in response to the received proximity signal, to move the vehicle to, by such movement, reduce a distance between the vehicle and the charging station while the received proximity signal is indicative of the vehicle being insufficiently proximate to the charging station for efficient power transfer. When the received proximity signal is indicative of the vehicle being sufficiently proximate to the charging station for efficient power transfer, the controller is configured to wirelessly transmit power from the wireless power transmitter to the wireless power receiver of the vehicle.

The wireless charging station may comprise a wireless radio transceiver. The controller may be configured to establish a second wireless communication link between the wireless radio transceiver and a wireless radio transceiver of the vehicle. The controller may be configured to receive, via the near-field proximity receiver circuit, an address of the wireless radio transceiver of the vehicle sent by the near-field proximity transmitter circuit of the vehicle. The controller of the charging station may be configured to communicate with a controller of the vehicle using the second wireless communication link during wireless transmission of power. The controller may be configured to establish the second wireless communication link prior to wirelessly transmitting power.

The controller may be configured to wirelessly transmit a pulse of power from the wireless power transmitter of the charging station to the wireless power receiving prior to receiving, at the proximity receiver circuit, the address of the wireless radio transceiver of the vehicle, sent by the proximity transmitter circuit. Wirelessly transmitting the pulse of power may occur in response to determining that the received proximity signal is indicative of the vehicle being sufficiently proximate to the charging station for efficient power transfer. After receiving the address of the wireless radio transceiver of the vehicle at the proximity receiver circuit, the controller may be configured to establish a pairing between the wireless radio transceiver of the charging station and the wireless radio transceiver of the vehicle to thereby establish the second wireless communication link.

The controller may be configured to receive, at the near-field proximity receiver circuit, the proximity signal sent wirelessly from the near-field proximity transmitter circuit of the vehicle during wireless transmission of power. The proximity signal and the address of the wireless radio transceiver of the vehicle received at the proximity receiver circuit may be time division multiplexed. The controller may be configured to de-multiplex the received proximity signal and address. The charging station may comprise a human-perceptible output device. The output instructions to move the vehicle may be provided by the human-perceptible output device and be perceptible to a human operator of the vehicle. The output instructions to move the vehicle may be provided to a driving controller of an autonomous vehicle. The output instructions provided to the driving controller of the autonomous vehicle may be output over the second wireless communication link.

The second wireless communication link may comprise a far-field wireless communication link. The wireless charging station may comprise a near-field wireless transmitter. The controller may be configured to transmit an address of the wireless radio transceiver of the charging station from the near-field wireless transmitter to a near-field wireless receiver of the vehicle. The near-field wireless transmitter and the near-field proximity receiver circuit of the charging station may be integrated into a charging station transceiver. The near-field wireless transmitter and the near-field proximity receiver circuit of the charging station may be separately embodied. The controller may be configured to determine when the received proximity signal is indicative of the vehicle being sufficiently proximate to the charging station for efficient power transfer by comparing the strength of the received proximity signal to a strength threshold.

Another aspect of the invention provides a method for communication between a vehicle and a wireless charging station to facilitate wireless power transfer from a wireless power transmitter of the wireless charging station to a wireless power receiver of the vehicle. The method comprises providing a vehicle comprising a near-field proximity transmitter circuit. A proximity signal is transmitted from the near-field proximity transmitter circuit to a near-field proximity receiver circuit of the wireless charging station. While the proximity signal received at the charging station is indicative of the vehicle being insufficiently proximate to the charging station for efficient power transfer, instructions output from the charging station to move the vehicle are received and the vehicle is moved in response to these instructions to reduce a distance between the vehicle and the charging station. When the received proximity signal is indicative of the vehicle being sufficiently proximate to the charging station for efficient power transfer, the wireless power receiver of the vehicle wirelessly receives power transmitted from the wireless power transmitter of the charging station.

A second wireless communication link may be established between a wireless radio transceiver of the charging station and a wireless radio transceiver of the vehicle. An address of the wireless radio transceiver of the vehicle may be transmitted from the near-field proximity transmitter circuit to the near-field proximity receiver circuit. The method may comprise communicating between a controller of the vehicle and a controller of the charging station using the second wireless communication link while the vehicle wirelessly receives power. The second wireless communication link may be established prior to wirelessly transmitting power.

The method may comprise receiving a pulse of power transmitted from the wireless power transmitter at the wireless power receiver prior to transmitting the address of the wireless radio transceiver of the vehicle. Receiving the pulse of power may occur after a determination is made that the received proximity signal is indicative of the vehicle being sufficiently proximate to the charging station for efficient power transfer. After transmitting the address of the wireless radio transceiver of the vehicle, a pairing may be established between the wireless transceiver of the charging station and the wireless radio transceiver of the vehicle to thereby establish the second wireless communication link.

The method may comprise transmitting the proximity signal while wirelessly receiving transmitted power. The proximity signal and the address of the wireless radio transceiver of the vehicle transmitted from the proximity transmitter circuit of the vehicle may be time division multiplexed. The instructions output from the charging station to move the vehicle may be perceptible to a human operator of the vehicle. The instructions output from the charging station to move the vehicle may be suitable for a driving controller of an autonomous vehicle. The instructions suitable for the driving controller of the autonomous vehicle may be received over the second wireless communication link.

The second wireless communication link may comprise a far-field wireless communication link. The vehicle may comprise a near-field wireless receiver. The method may comprise receiving an address of the wireless radio transceiver of the charging station, sent from a near-field wireless transmitter of the charging station, at the near-field wireless receiver. The near-field wireless receiver and the near-field proximity circuit of the vehicle may be integrated into a vehicle transceiver. The near-field wireless receiver and the near-field proximity transmitter circuit of the vehicle may be separately embodied. The method may comprise determining when the received proximity signal is indicative of the vehicle being sufficiently proximate to the charging station for efficient power transfer by comparing the strength of the received proximity signal to a strength threshold.

Another aspect of the invention provides an electric vehicle for receiving wireless power transferred from a wireless power transmitter of a wireless charging station. The electric vehicle comprises a near-field proximity transmitter circuit, a wireless power receiver, and a controller operative connected to the near-field proximity receiver circuit and to the wireless power receiver. The near-field transmitter circuit is operative to transmit a near-field proximity signal to a near-field proximity receiver of the charging station. When the received proximity signal is indicative of the vehicle being sufficiently proximate to the charging station for efficient power transfer, power transmitted from the wireless power transmitter of the wireless charging station is wirelessly received at the wireless power receiver of the vehicle.

The vehicle may comprise a wireless radio transceiver. The controller may be configured to establish a second wireless communication link between the wireless radio transceiver of the vehicle and a wireless radio transceiver of the charging station. The controller may be configured to transmit, via the near-field proximity transmitter circuit, an address of the wireless radio transceiver of the vehicle to the near-field proximity receiver circuit. The controller of the vehicle may be configured to communicate with a controller of the charging station using the second communication link while wirelessly receiving transmitted power at the wireless power receiver of the vehicle. The controller may be configured to establish the second wireless communication link prior to wirelessly receiving transmitted power.

The controller may be configured to detect a wirelessly transmitted pulse of power from the wireless power transmitter of the charging station received at the wireless power receiver. In response to the detecting the pulse of power, the controller may be configured to transmit, via the near-field proximity transmitter circuit of the vehicle, the address of the wireless radio transceiver of the vehicle to the near-field proximity receiver circuit of the charging station. After transmitting the address of the wireless radio transceiver of the vehicle, the controller may be configured to establish a pairing between the wireless radio transceiver of the vehicle and the wireless radio transceiver of the charging station to thereby establish the second wireless communication link.

The controller may be configured to time division multiplex the transmission of the near-field proximity signal and the address of the wireless radio transceiver of the vehicle. The controller may be configured to transmit the near-field proximity signal to the near-field proximity receiver circuit while wirelessly receiving transmitted power. The controller may be configured to receive instructions for an autonomous vehicle driving controller to move the vehicle to reduce a distance between the vehicle and the charging station. The instructions for the autonomous vehicle driving controller may be received over the second communication link. The second wireless communication link may comprise a far-field wireless communication link.

The vehicle may comprise a near-field wireless receiver. The controller may be configured to receive an address of the wireless radio transceiver of the charging station, sent from a near-field wireless transmitter of the charging station, at the near-field wireless receiver. The near-field wireless receiver and the near-field proximity transmitter circuit of the vehicle may be integrated into a vehicle transceiver. The near-field wireless receiver and the near-field proximity transmitter circuit may be separately embodied.

Another aspect of the invention provides a method for communication between a wireless charging station and a vehicle to facilitate wireless power transfer from a wireless power transmitter of the wireless charging station to a wireless power receiver of the vehicle. The method comprises providing a wireless charging station comprising: a near-field proximity transmitter circuit, a far-field wireless transceiver, and a wireless power transmitter. The near-field proximity transmitter circuit transmits a proximity signal to a near-field proximity receiver circuit of the vehicle. The proximity signal received at the near-field proximity receiver circuit is interpretable to determine whether the vehicle is sufficiently proximate to the charging station for efficient power transfer. The near-field proximity transmitter circuit transmits an address of the far-field wireless transceiver to the near-field proximity receiver circuit. Power is wirelessly transmitted from the wireless power transmitter of the charging station to the wireless power receiver of the vehicle.

A second wireless communication link may be established between the wireless radio transceiver of the charging station and a wireless radio transceiver of the vehicle. The method may comprise communicating between a controller of the charging station and a controller of the vehicle using the second wireless communication link during wireless transmission of power. Establishing the second wireless communication link may occur prior to wirelessly transmitting power.

The method may comprise receiving an indication that the vehicle is sufficiently proximate to the charging station for efficient power transfer. The indication may be received at the wireless radio transceiver of the charging station over the second wireless communication link. After transmitting the address of the far-field wireless transceiver of the vehicle, a pairing may be established between the wireless radio transceiver of the charging station and the wireless radio transceiver of the vehicle to thereby establish the second wireless communication link. The proximity signal may be transmitted during wireless transmission of power.

The proximity signal and the address of the far-field wireless transceiver of the charging station transmitted from the near-field proximity transmitter circuit may be time division multiplexed. The second wireless communication link may comprise a far-field wireless communication link. The method may comprise determining when the received proximity signal is indicative of the vehicle being sufficiently proximate to the charging station for efficient power transfer by comparing the strength of the received proximity signal to a strength threshold.

Another aspect of the invention provides a wireless charging station for wireless power transfer from the wireless charging station to a wireless power receiver of a vehicle. The wireless charging station comprises a near-field proximity transmitter circuit, a far-field wireless transceiver, a wireless power transmitter, and a controller operatively connected to the near-field proximity receiver circuit, to the far-field wireless transceiver, and to the wireless power transmitter. The near-field transmitter circuit is operative to transmit a near-field proximity signal to a near-field proximity receiver circuit of the vehicle. The proximity signal received at the near-field proximity transmitter circuit is interpretable to determine whether the vehicle is sufficiently proximate to the charging station for efficient power transfer. The near-field proximity circuit is operative to transmit an address of the far-field wireless transceiver to the near-field proximity receiver circuit of the vehicle. The wireless power transmitter is operative to wirelessly transmit power from the wireless power transmitter of the charging station to the wireless power receiver of the vehicle.

The controller may be configured to establish a second wireless communication link between the wireless radio transceiver of the charging station and a wireless radio transceiver of the vehicle. The controller may be configured to communicate with a controller of the vehicle using the second wireless communication link during wireless transmission of power. The controller may be configured to establish the second wireless communication link prior to wirelessly transmitting power.

The controller may be configured to cause the wireless transmission of power in response to receiving an indication that the vehicle is sufficiently proximate to the charging station for efficient power transfer. The indication may be received at the wireless radio transceiver of the charging station over the second wireless communication link. The controller may be configured to establish a pairing between the wireless radio transceiver of the charging station and the wireless radio transceiver of the vehicle, thereby establishing the second wireless communication link, after transmitting the address of the far-field wireless transceiver.

The proximity signal and the address of the far-field wireless transceiver of the charging station transmitted from the near-field proximity transmitter circuit may be time division multiplexed. The second wireless communication link may comprise a far-field wireless communication link. A controller of the vehicle may be operative to determine when the received proximity signal is indicative of the vehicle being sufficiently proximate to the charging station for efficient power transfer by comparing the strength of the received proximity signal to a strength threshold.

Another aspect of the invention provides a method for communication between a vehicle and a wireless charging station to facilitate wireless power transfer from a wireless power transmitter of the wireless charging station to a wireless power receiver of the vehicle. The method comprises providing a vehicle comprising a near-field proximity receiver circuit and a wireless power receiver. The near-field proximity receiver circuit receives a proximity signal from a near-field proximity transmitter circuit of the charging station. The received proximity signal is interpretable to determine whether the vehicle is sufficiently proximate to the charging station for efficient power transfer. The near-field proximity receiver circuit receives an address of a far-field wireless transceiver of the charging station from the near-field proximity transmitter circuit. The wireless power receiver of the vehicle wirelessly receives power from a wireless power transmitter of the charging station.

The method may comprise establishing a second wireless communication link between the wireless radio transceiver of the charging station and a wireless radio transceiver of the vehicle. The method may comprise communicating between a controller of the vehicle and a controller of the charging station using the second wireless communication link during wirelessly receiving power. The second wireless communication link may be established prior to wirelessly receiving power. The method may comprise transmitting an indication that the vehicle is sufficiently proximate to the charging station for efficient power transfer. The indication may be transmitted via the wireless radio transceiver of the vehicle over the second wireless communication link.

The method may comprise establishing a paring between the wireless radio transceiver of the vehicle and the wireless radio transceiver of the charging station to thereby establish the second wireless communication link. The pairing may be established after receiving the address of the far-field wireless transceiver of the charging station, sent from the near-field proximity transmitter circuit, at the near-field proximity receiver circuit.

The method may comprise receiving, via the near-field proximity receiver circuit, the proximity signal from the near-field proximity transmitter circuit of the charging station during wireless transmission of power. Receiving the proximity signal and the address of the far-field wireless transceiver of the charging station at the near-field proximity receiver circuit may be time division multiplexed. The second wireless communication link may comprise a far-field wireless communication link. The method may comprise determining when the received proximity signal is indicative of the vehicle being sufficiently proximate to the charging station for efficient power transfer by comparing the strength of the received proximity signal to a strength threshold.

Another aspect of the invention provides an electric vehicle for receiving wireless power transferred from a wireless power transmitter of a wireless charging station. The electric vehicle comprises a near-field proximity receiver circuit, a wireless power receiver, and a controller connected to the near-field proximity receiver circuit and to the wireless power receiver. The near-field proximity receiver circuit is operative to receive a proximity signal from a near-field proximity transmitter circuit of the charging station. The received proximity signal is interpretable to determine whether the vehicle is sufficiently proximate to the charging station for efficient power transfer. The near-field proximity receiver circuit is operable to receive an address of a far-field wireless transceiver of the charging station from the near-field proximity transmitter circuit of the charging station. The wireless power receiver is operative to wirelessly receive power transmitted from a wireless power transmitter of the charging station.

The controller may be configured to establish a second wireless communication link between the wireless radio transceiver of the charging station and a wireless radio transceiver of the vehicle. The controller of the vehicle may be configured to communicate with a controller of the charging station using the second wireless communication link during wirelessly receiving power. The controller may be configured to establish the second wireless communication link prior to wirelessly receiving power. The controller may be configured to transmit an indication that the vehicle is sufficiently proximate to the charging station for efficient power transfer. The indication may be transmitted by the wireless radio transceiver of the vehicle over the wireless communication link.

The controller may be configured to establish a pairing between the wireless radio transceiver of the vehicle and the wireless radio transceiver of the charging station to thereby establish the second wireless communication link after receiving the address of the far-field wireless transceiver of the charging station. The near-field proximity receiver circuit may receive the proximity signal from the near-field proximity transmitter circuit during wirelessly receiving power.

The controller may be configured to time-division demultiplex the receipt of the proximity signal and the address of the far-field wireless transceiver of the charging station. The second wireless communication link may comprise a far-field wireless communication link. The controller may be configured to determine when the received proximity signal is indicative of the vehicle being sufficiently proximate to the charging station for efficient power transfer by comparing the strength of the received proximity signal to a strength threshold.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic illustration of the prior art principle of magnetic inductive wireless charging by a power transmitter coil and a wireless power receiver coil in close proximity.

FIG. 2 is a schematic illustration of the prior are principle of magneto-dynamic coupling (MDC) between two rotating magnets in a wireless power transfer system.

FIG. 3 is a flowchart showing a method for positioning an electric vehicle relative to a charging station and then pairing the electric vehicle with the charging station according to an example embodiment.

FIG. 4A is a schematic representation of a ground assembly (e.g. a charging station) for wirelessly transferring power to an electric vehicle using MDC charging technology according to an example embodiment.

FIG. 4B is a schematic representation of a vehicle assembly (e.g. an electric vehicle) for wirelessly receiving power using MDC charging technology according to an example embodiment.

FIG. 4C is a schematic diagram illustrating a position measurement and an alignment measurement according to an example embodiment.

FIG. 5A is a schematic representation of a ground assembly (e.g. a charging station) for wirelessly transferring power to an electric vehicle using inductive charging technology according to an example embodiment.

FIG. 5B is a schematic representation of a vehicle assembly (e.g. an electric vehicle) for wirelessly receiving power using inductive charging technology according to an example embodiment.

FIG. 6A is a flowchart showing an example method which may be executed by a suitable configured controller on an electric vehicle to pair with a wireless energy provider.

FIG. 6B is a flowchart showing an example method which may be executed by a suitably configured controller on a wireless energy provider to pair with an electric vehicle.

FIG. 7A is a graph depicting example signaling logic utilized by a proximity communication system for positioning according to an example embodiment.

FIG. 7B is a graph depicting example signaling logic utilized by a proximity communication system for address communication according to an example embodiment.

FIG. 8A is a graph depicting signal processing utilized by a proximity communication system during an electric vehicle's approach according to an example embodiment.

FIG. 8B is a graph depicting signaling logic utilized by a wireless power transmitter during an electric vehicle's approach according to an example embodiment.

FIG. 9 is a more detailed schematic view of the FIG. 4B proximity transmitter circuit and the FIG. 4A proximity receiver circuit according to a particular embodiment.

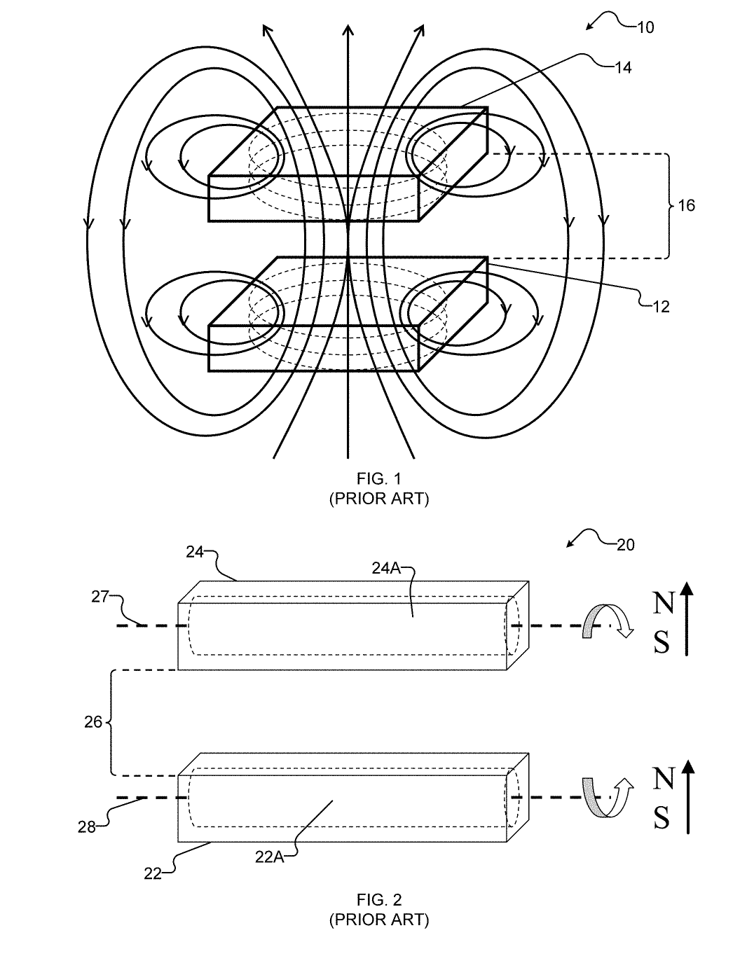

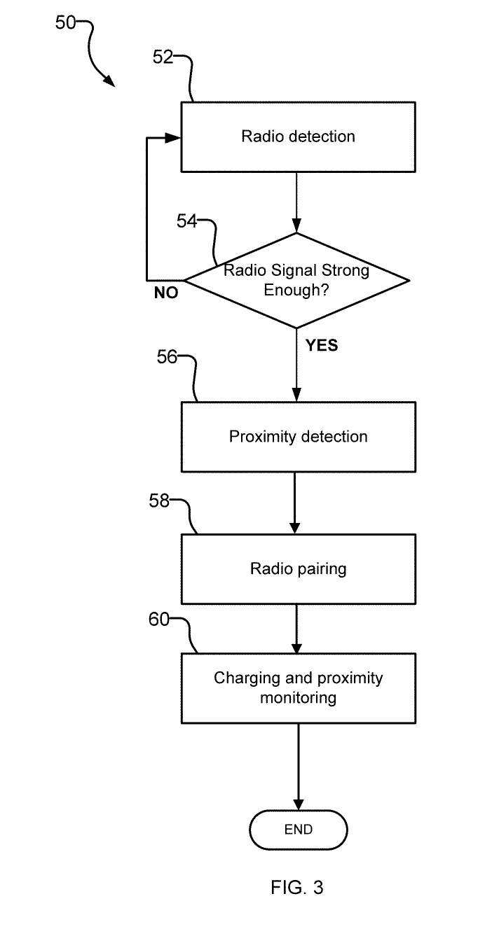

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Aspects of the disclosed technology provide methods and systems for wireless pairing between wireless communication devices in wireless energy transfer networks. An example application of such methods and systems is positioning an electric vehicle relative to, and pairing the electric vehicle with, a wireless charging station. Such positioning and pairing permits the wireless charging station to transmit wireless energy to the electric vehicle, thereby charging the electric vehicle.

Some far-field wireless communication protocols (such as Bluetooth™, Zigbee™ and/or the like) involve so-called “pairing” between pairs of communication devices. As is known, such pairing and the corresponding communication can be between suitably configured controllers and/or suitably configured communication components in the paired devices. For brevity, unless the context dictates otherwise, this disclosure may refer to pairing and/or wireless communication between devices that incorporate such suitably configured controllers and/or suitably configured communication components, without referring expressly to the controllers or communication components that perform the actual communication. For example, this disclosure may refer to pairing and/or communication between wireless energy providers (e.g. charging stations) and wireless energy consumers (e.g. electric vehicles). Such references (or similar references) to pairing and/or communication between these types of devices should be understood, unless the context dictates otherwise, to refer to pairing and/or communication between the controllers and/or communication components incorporated into or otherwise associated with such devices.

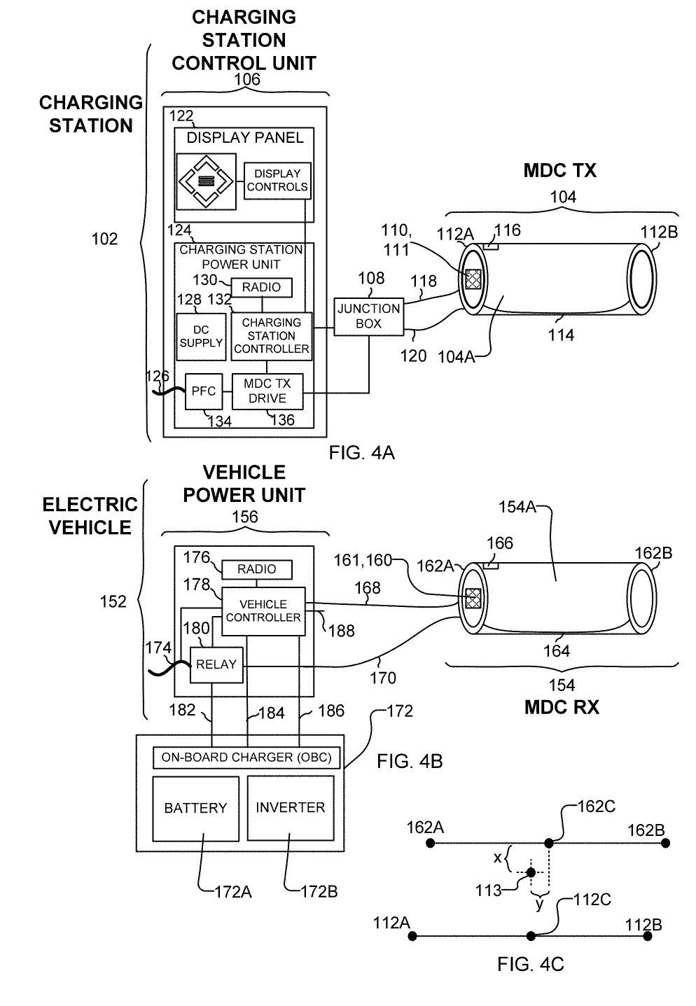

FIG. 3 shows a method 50 for positioning an electric vehicle (e.g. wireless power consumer) relative to a wireless charging station (e.g. wireless power provider) and then pairing the electric vehicle with the wireless charging station according to an example embodiment. As will be explained in more detail below, each wireless charging station may comprise: a radio transceiver configured to operate using a suitable far-field wireless protocol, such as ZigBee™, Bluetooth™ and/or the like, a high power wireless energy transmitter apparatus, a low power near-field proximity receiver circuit and a suitably configured controller; and each electric vehicle may comprise: a radio transceiver a radio transceiver configured to operate using a suitable far-field wireless protocol, such as ZigBee™, Bluetooth™ and/or the like, a high power wireless energy receiver apparatus, a low power near-field proximity transmitter circuit and a suitably configured controller.

As is known to those skilled in the art, far-field wireless communication protocols operate at distances (from the antenna) that are greater than the wavelength of their corresponding electromagnetic frequency and typically greater than two wavelengths. In contrast, near-field communication protocols operate at distances (from the antenna) that are less that the wavelength of their corresponding electromagnetic frequency. As compared to near-field communications, far-field communications at a given electromagnetic frequency have greater communication range.

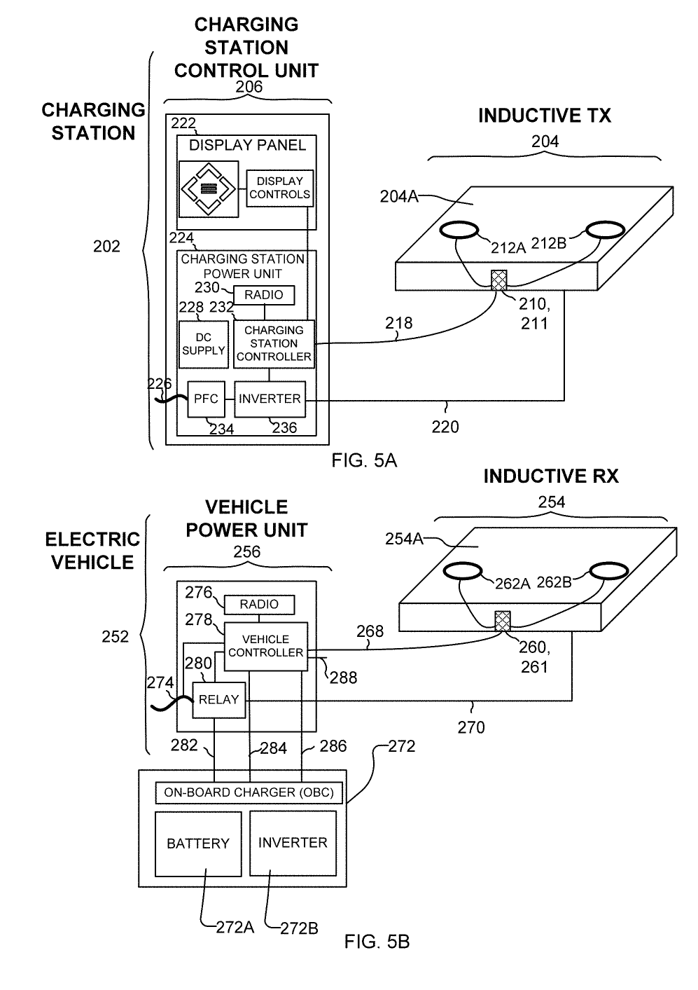

Method 50 commences at block 52, where an electric vehicle detects if it is in the proximity of a wireless charging station. In a network of wireless charging stations comprising a plurality of wireless charging stations, each wireless charging station may comprise a far-field radio (e.g. wireless) transceiver—e.g. far-field wireless radio transceiver 130 of charging station 102 (FIG. 4A). In block 52, a radio signal emitted by the radio transceiver of one of the wireless charging stations is detected by a corresponding radio transceiver of the electric vehicle (e.g. far-field wireless radio transceiver 176 of vehicle 152 (FIG. 4B)). The radio signals transmitted and received in block 52 may comprise so-called far-field signals (i.e. where spacing between radios (or more specifically, their antennas) is greater than their radio (electromagnetic) wavelengths or, in some embodiments greater than twice their wavelengths). A possible, but non-limiting, frequency for such far-field communications is 2.4 GHz.

Method 50 then proceeds to block 54. Block 54 may be performed by vehicle controller 178 (see FIG. 4B) in conjunction with the hardware under its control. In block 54, if the block 52 detected radio signal (detected at the vehicle, for example, by radio transceiver 176) indicates that the electric vehicle is in close enough proximity with the wireless charging station (e.g. if the block 52 detected radio signal is stronger than a suitable threshold), method 50 proceeds (via the block 54 YES branch) to step 56. In this disclosure, reference may be made to the “strength” of a signal, as in the case, for example, in some embodiments of the block 54 evaluation. Unless the context dictates otherwise, the strength of a signal may comprise any suitable metric for evaluating the strength of a signal, such as, by way of non-limiting example: the power of the signal, other metric(s), such as received signal strength indicator (RSSI) or the like, based on the power of the signal, the peak amplitude of the signal, other metric(s) based on the peak amplitude of the signal, the autocorrelation of the signal, other metric(s) based on the autocorrelation of the signal or some other suitable strength metric. In some embodiments, block 54 involves measuring the received signal strength indicator (RSSI) of the block 52 detected radio signal. In such embodiments, decision block 54 may evaluate whether the RSSI signal exceeds a threshold value. In some embodiments, each of the electric vehicle and the plurality of wireless charging stations comprises a radio transceiver to form a network of radio nodes. In some embodiments, block 54 inquiry may then involve using node discovery techniques, where radio transceivers on the electric vehicle and one or more wireless charging stations ascertain the status of other radio nodes. Such node discovery techniques may determine that the electric vehicle is close enough to a wireless charging station. In any case, where block 56 determines that the block 52 signal is sufficiently strong, method 50 proceeds to block 56 (via the block 54 YES branch).

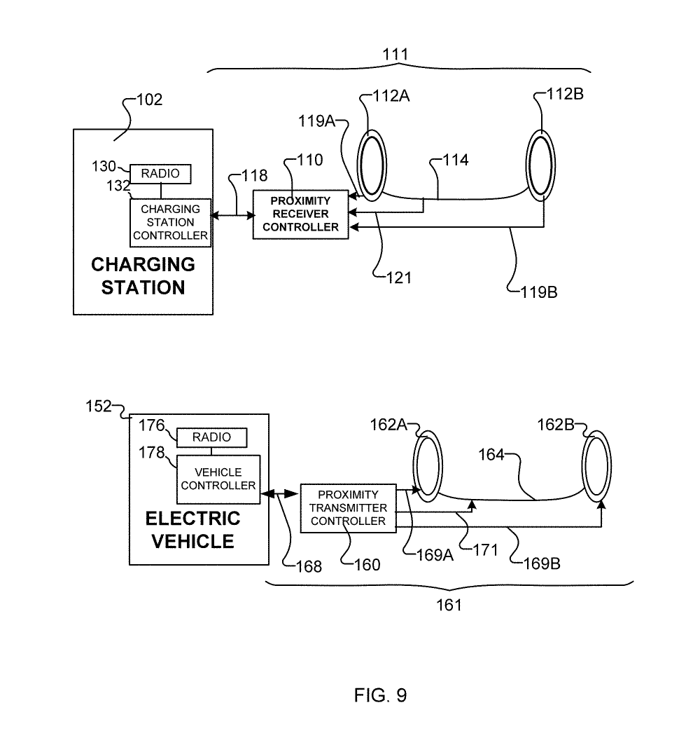

At block 56, a proximity transmitter of the vehicle (e.g. proximity transmitter circuit 161 of vehicle 152 in FIG. 4B and FIG. 9) may transmit one or more proximity beacon signals to charging station 102 (e.g. to proximity receiver circuit 111 of charging station 102 in FIG. 4A) on a radio channel that is different from the block 52 radio channel. The block 56 radio channel may comprise a so-called “near-field” radio channel (i.e. where spacing between devices is much less than the radio wavelengths), which is operative over a lower spatial separation than the block 52 “far-field” radio signals. In one non-limiting example, the frequency of the near-field communication between proximity transmitter circuit 161 and proximity receiver circuit 111 (e.g. in block 56 and other blocks described herein) is 125 kHz, although other frequencies are possible. The proximity signal receiver of a wireless charging station (e.g. proximity receiver circuit 111 of FIG. 4A) may detect the beacon signals and, in response to receipt of these proximity signals, may transmit positioning instructions either to the electric vehicle itself (e.g. to the driving controller of an autonomous vehicle) or to the operator of the electric vehicle.

In the case of an autonomous vehicle, such instructions may be communicated from charging station 102 to vehicle 152 in a variety of ways. In some embodiments, charging station 102 comprises a near-field transmitter or near field transceiver in addition to or in the alternative to near-field proximity receiver circuit 111 and vehicle 152 comprises a near-field receiver or near-field transceiver in addition to or in the alternative to near-field proximity transmitter circuit 161. In such embodiments, instructions may be communicated from charging station 102 (via its near-field transmitter or near field transceiver) to the vehicle 152 (via its near-field receiver or near-field transceiver). In some embodiments (as is the case with the illustrated embodiment), charging station 102 does not have the ability to transmit near-field signals. In such embodiments, the transmission of positioning instructions may occur after pairing (in block 58) the far-field radio transceiver 130 of charging station 102 with the far-field radio transceiver 176 of vehicle 152. After such pairing, position instructions may be communicated from charging station 102 (via its far-field radio transceiver 130) to vehicle 152 (far-field radio transceiver 176). Once received at vehicle 152, such positioning instructions may be provided to the vehicle autopilot system (not shown) over the vehicle's CAN bus. Such position instructions may comprise one or more of: an indication of the current position of the vehicle relative to a target position, an indication to continue moving closer to the target position, an indication to stop the vehicle, an indication to retry the docking sequence and/or the like.

In the case of where position instructions are provided to the driver of a vehicle (as is the case in the illustrated embodiment), such instructions may be provided in any suitable human perceptible form, such as in the form of a suitable visual display or auditory command in the case of communicating with a vehicle operator (see display panel 122 of charging station 102 in FIG. 4A).

In either case (providing position instructions to an autonomous vehicle or to a vehicle driver), such instructions may instruct the vehicle or the operator of the vehicle how to position the electric vehicle 152 relative to the wireless charging station 102 to receive wireless power (e.g. efficiently and safely) from the wireless charging station. Block 56 concludes when the vehicle is in a position to receive wireless power from the charging station.

Method 50 then proceeds to block 58, where a radio (wireless) pairing (e.g. a far-field radio pairing) between the electric vehicle 152 and the wireless charging station 102 may be implemented. Although the block 58 pairing is for the purposes of establishing far-field communication (e.g. between radio 130 of charging station 102 and radio 176 of vehicle 152), the block 58 pairing may be established, at least in part, by near-field communication (e.g. between proximity receiver circuit 111 of charging station 102 and proximity transmitter circuit 161 of vehicle 152). For example, the address of vehicle radio 176 may be communicated to charging station 102 by proximity transmitter circuit 161 and received at charging station 102 via proximity receiver circuit 111. In one particular embodiment, the block 58 pairing process may be implemented using some or all of the following sub-steps. First, when a wireless charging station's proximity signal receiver detects that a vehicle is sufficiently proximate for energy transfer (e.g. when the strength of the block 56 proximity signals received by proximity receiver circuit 111 is above a configurable threshold), wireless charging station 102 may begin high power wireless energy transfer in the form of a pulse or step using its high power energy transmitter 104 (FIG. 4A). This high power energy pulse (or step) may be received by the high power energy receiver 164 (FIG. 4B) of the electric vehicle 152 and/or other suitable sensors on the vehicle (not shown). In response to detecting such a pulse/step, a vehicle controller 178 may communicate the vehicle's unique radio address (e.g. the address of vehicle far-field radio 176) to the wireless charging station 102 using its low power proximity transmitter circuit 161. The low power proximity receiver circuit 111 on the wireless charging station 102 may receive and decode the unique radio address (of vehicle radio 176) and may deliver this address to the charging station controller 132. After receiving the vehicle's radio (wireless) address (e.g. the address of vehicle far-field radio 176), the charging station controller 132 may instruct its radio transceiver 130 to initiate pairing with the vehicle's radio transceiver 176 to thereby pair the charging station 102 with the electric vehicle 152.

Any suitable protocol for far-field wireless communication between the electric vehicle and the wireless charging station are possible. For example, each of the electric vehicle and the wireless charging station may comprise suitably configured far-field wireless communication components to implement wireless communication protocols, such as, without limitation:
ZigBee (IEEE standard 802.15.4);
Bluetooth (e.g. IEEE standard 802.15.1); and/or
the like.

Following successful radio pairing at block 58, method 50 proceeds to block 60, where wireless charging occurs. As discussed above, the wireless charging station 102 comprises a high power wireless power transmitter 104 and the electric vehicle 152 comprises a high power wireless power receiver 154. The wireless charging station 102 paired to the electric vehicle 152 at block 58 transmits wireless power through its wireless power transmitter 104 to the high power wireless power receiver 154 on the vehicle at block 60. A battery 172A of the electric vehicle 152 may be connected to the wireless power receiver 154 through suitable electronic circuitry (e.g. OBC circuitry 172) to receive electric power that charges the battery.

Block 60 may also comprise monitoring the proximity of the vehicle 152 to the wireless charging station 102 while charging. To monitor the proximity of the vehicle 152 to the wireless charging station 102 while charging, the proximity transmitter circuit 161 on the vehicle may emit proximity beacon signals which may be received by the proximity receiver circuit 111 of the wireless charging station 102 to ascertain the vehicle's position relative to the charging station. Method 50 may terminate when the emitted proximity beacon signals indicate that the electric vehicle 152 is no longer proximate to the wireless charging station 102 (e.g. if the strength of the proximity beacon signal(s) received at the charging station 102 falls below a configurable threshold), in which case the controller 132 of the charging station 102 may stop wireless power transmission. In some embodiments, method 50, and thus wireless power transmission, may be terminated when the electric vehicle 152 transmits a signal to the wireless charging station 102 (e.g. via radios 176, 130) that the vehicle's battery has attained a sufficient level of charge. Additionally or alternatively, method 50 may be terminated when the charging station 102 observes that the electric vehicle 152 has stopped drawing wireless power.

FIGS. 4A and 4B respectively depict schematic block diagrams of a wireless power provider (in the case of the illustrated embodiment, a charging station 102, also referred to as a ground assembly (GA) 102) and a wireless power consumer (in the case of the illustrated embodiment, an electric vehicle 152, also referred to as vehicle assembly (VA) 152). Together, charging station 102 and electric vehicle 152 may provide a wireless power transfer (WPT) system employing magneto-dynamic coupling (MDC) technology according to an example embodiment of the invention.

In the illustrated embodiments, the FIG. 4A charging station 102 comprises MDC wireless energy transmitter 104 and charging station control unit 106, which are operatively connected to one another via junction box 108. AC mains power is supplied to charging station control unit 106 which in turn converts the electrical power to a form that is suitable for the MDC transmitter 104. MDC transmitter 104 supplies wireless power to a MDC wireless energy receiver 154 of electric vehicle 152, as discussed in more detail below.

In the illustrated embodiment, MDC transmitter 104 comprises a proximity receiver circuit 111, which itself may comprise: proximity receiver controller 110, first and second proximity receiver coils 112A and 112B, proximity receiver coil signal cable 114, and proximity receiver signal cable 118. Proximity receiver coil signal cable 114 communicates proximity signals received at proximity receiver coils 112A and 112B to proximity receiver controller 110 for processing. Proximity receiver circuit 111 (described in more detail below) may comprise a wireless receiver for so-called “near-field” wireless communications, which involve relatively low spatial separation between transmitter and receiver (e.g. when compared to far-field radio 130). In the illustrated embodiment, MDC transmitter 104 also comprises temperature and rotor speed sensors 116, drive power cable 120 and a rotor 104A comprising one or more permanent magnets (not shown).

Charging station control unit 106 of the FIG. 4A embodiment comprises a display panel 122 and a charging station power unit 124 (also referred to as a ground assembly power unit 124). Charging station power unit 124 of the illustrated embodiment comprises a power supply connection 126 to external power (not shown), DC supply 128, wireless transceiver (far-field) radio 130, charging station controller 132 (also referred to as ground assembly controller 132), power factor correction (PFC) module 134, and MDC transmitter drive 136. Power supply connection 126 is connectable to any suitable AC power source and delivers AC power to PFC module 134 wherein the power factor of the supplied AC power may be increased. MDC transmitter drive 136 is configured to cause the rotor 104A of MDC transmitter 104 to move (e.g. rotate about an axis) for MDC wireless power transmission.

In the illustrated embodiments, the FIG. 4B electric vehicle 152 comprises vehicle power unit 156 (also referred to as vehicle assembly power unit (VAPU) 156), vehicle on-board charger (OBC) 172 and MDC receiver 154. In the illustrated embodiment, MDC receiver 154 comprises proximity transmitter circuit 161 which itself comprises: proximity transmitter controller 160, first and second proximity transmitter coils 162A and 162B, proximity transmitter coil signal cable 164, and proximity transmitter signal cable 168. Proximity transmitter controller 160 communicates signals to proximity transmitter coils 162A and 162B to transmit proximity signals through proximity transmitter coil signal cable 164. Proximity transmitter circuit 161 (described in more detail below) may comprise a wireless transmitter for so-called “near-field” wireless communications, which involve relatively low spatial separation between transmitter and receiver (e.g. when compared to far-field radio 176). In the illustrated embodiment, MDC receiver 154 also comprises temperature and rotor speed sensors 166, receiver power cable 170 and a rotor 154A comprising one or more permanent magnets (not shown).

MDC receiver 154 receives wireless power from MDC transmitter 104 (FIG. 4A) and provides electrical power (through conductive windings) to vehicle power unit 156. Vehicle power unit 156 is responsible, among other things, for relaying power received at vehicle power unit 156 to a vehicle's on-board charger (OBC) 172. Vehicle power unit 156 may optionally comprise a conductive charging inlet 174 for a wired connection to an electric vehicle supply equipment (EVSE) or any other appropriate external power supply. Vehicle power unit 156 may further comprise a wireless (far-field) transceiver (radio) 176, vehicle power unit (VAPU) controller 178, relay 180, OBC power outlet cable 182, OBC signal outlet cable 184, vehicle Controller Area Network (CAN or CANBUS) signal cable 186, and vehicle DC power connection 188. In some embodiments, vehicle power unit 156 additionally relays energy produced from the use of systems which convert mechanical energy produced during braking into electrical energy (i.e. regenerative braking).

In some embodiments, OBC 172 comprises a battery 172A and a power inverter module 172B. Power inverter module 172B may be suitable to convert AC energy from charging inlet 174, MDC receiver 154, or any other suitable AC energy source to DC energy for storage in battery 172A.

MDC wireless power transmitter 104 may comprise any suitable wireless power transmitter. Similarly, MDC wireless power receiver 154 may comprise any suitable wireless power receiver. For example MDC wireless power transmitter 104 may comprise a rotor 104A comprising one or more permanent magnets. Rotor 104A may be mounted for movement (e.g. mounted to be rotatable and/or pivotable about an axis) to generate a magnetic field (e.g. a time-varying-magnetic field) to couple to one or more permanent magnets in rotor 154A of MDC wireless power receiver 154, allowing for the transfer of magnetic torque. Exemplary MDC wireless power transmission systems are described in Patent Cooperation Treaty Patent Application No. PCT/CA2010/000252 filed 26 Feb. 2010 for SYSTEMS AND METHODS FOR DIPOLE ENHANCED INDUCTIVE POWER TRANSFER, Patent Cooperation Treaty Patent Application No. PCT/CA2015/050736 filed 5 Aug. 2015 for MULTI-MODE CHARGING SYSTEM, Patent Cooperation Treaty Patent Application No. PCT/CA2015/050327 filed 20 Apr. 2015 for MAGNETIC FIELD CONFIGURATION FOR A WIRELESS ENERGY TRANSFER SYSTEM, and Patent Cooperation Treaty Patent Application No. PCT/CA2015/050763 filed 13 Aug. 2015 for METHODS AND APPARATUS FOR MAGNETICALLY COUPLED WIRELESS POWER TRANSFER, each of which is hereby incorporated by reference herein in its entirety.

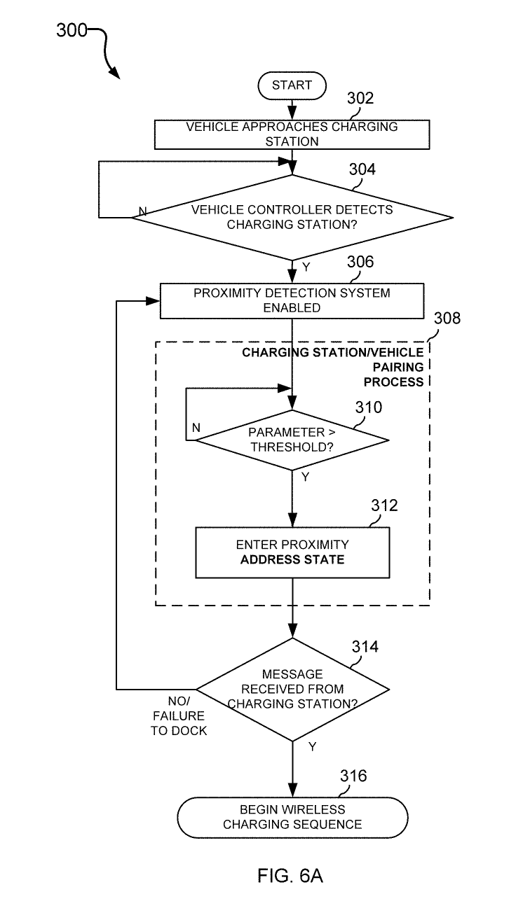

FIGS. 5A and 5B respectively depict schematic block diagrams of a wireless power provider (in the case of the illustrated embodiment, a charging station 202, also referred to as a ground assembly (GA) 202) and a wireless power consumer (in the case of the illustrated embodiment, an electric vehicle 252, also referred to as vehicle assembly (VA) 252). Together, charging station 202 and electric vehicle 252 may provide a wireless power transfer (WPT) system employing inductive charging technology according to an example embodiment of the invention. Other than for the manner in which power is transferred between charging station 202 and electric vehicle 252 and possibly some of the power handling circuitry of charging station 202 and electric vehicle 252, charging station 202 may be similar to charging station 102 described elsewhere herein and vehicle 252 may be similar to vehicle 152 described elsewhere herein. Components of charging station 202 and electric vehicle 252 preceded by the reference digit “2” may be similar to components of charging station 102 and electric vehicle 152 preceded by the reference digit “1”.

In the illustrated embodiments, the FIG. 5A charging station 202 comprises inductive charging transmitter 204 and charging station control unit 206. AC mains power is supplied to charging station control unit 206 which in turn converts the electrical power to a form that is suitable for the inductive charging transmitter 204. Inductive charging transmitter 204 supplies wireless power to an inductive charging receiver 254 of electric vehicle 252, as discussed in more detail below.

In the illustrated embodiment, inductive charging transmitter 204 comprises a proximity receiver circuit 211, which itself may comprise: proximity receiver controller 210, first and second proximity receiver coils 212A and 212B and proximity receiver signal cable 218. Proximity receiver circuit 211 may be substantially similar to proximity receiver circuit 111 and may provide a wireless receiver for so-called “near-field” wireless communications, which involve relatively low spatial separation between transmitter and receiver (e.g. when compared to far-field radio 230). In the illustrated embodiment, inductive charging transmitter 204 also comprises drive power cable 220 and one or more transmitter coils 204A through which a magnetic field is generated (not shown).

Charging station control unit 206 of the FIG. 5A embodiment comprises a display panel 222 and a charging station power unit 224 (also referred to as a ground assembly power unit 224). Charging station power unit 224 of the illustrated embodiment comprises a power supply connection 226 to external power (not shown), DC supply 228, wireless (far-field) transceiver radio 230, charging station controller 232 (also referred to as ground assembly controller 232), power factor correction (PFC) module 234, and inverter 236. Power supply connection 226 is connectable to any suitable AC power source and delivers AC power to PFC module 234 wherein the power factor of the supplied AC power may be increased. Inverter 236 is configured to transfer power to transmitter coil(s) 204A of inductive charging transmitter 204, thereby generating a magnetic field.

In the illustrated embodiments, the FIG. 5B electric vehicle 252 comprises vehicle power unit 256 (also referred to as vehicle assembly power unit (VAPU) 256), vehicle on-board charger (OBC) 272 and inductive charging receiver 254. In the illustrated embodiment, inductive charging receiver 254 comprises proximity transmitter circuit 261 which itself comprises: proximity transmitter controller 260, first and second proximity transmitter coils 262A and 262B and proximity transmitter signal cable 268. Proximity transmitter circuit 261 may comprise a wireless transmitter for so-called “near-field” wireless communications, which involve relatively low spatial separation between transmitter and receiver (e.g. when compared to far-field radio 276). In the illustrated embodiment, inductive charging receiver 254 also comprises receiver power cable 270 and one or more receiver coils 254A through which a magnetic field is generated (not shown).

Inductive charging receiver 254 receives wireless power from inductive power transmitter 204 (FIG. 5A) and provides electrical power (through conductive windings) to vehicle power unit 256. Vehicle power unit 256 is responsible, among other things, for relaying power received at vehicle power unit 256 to a vehicle's on-board charger (OBC) 272. Vehicle power unit 256 may optionally comprise a conductive charging inlet 274 for a wired connection to an electric vehicle supply equipment (EVSE) or any other appropriate external power supply. Vehicle power unit 256 may further comprise a wireless transceiver (radio) 276, vehicle power unit (VAPU) controller 278, relay 280, OBC power outlet cable 282, OBC signal outlet cable 284, vehicle Controller Area Network (CAN) signal cable 286, and vehicle DC power connection 288. In some embodiments, vehicle power unit 256 additionally relays energy produced from the use of systems which convert mechanical energy produced during braking into electrical energy (i.e. regenerative braking).

In some embodiments, OBC 272 comprises a battery 272A and a power inverter module 272B. Power inverter module 272B may be suitable to convert AC energy from charging inlet 274, inductive charging receiver 254, or any other suitable AC energy source to DC energy for storage in battery 272A.

Method 50 (FIG. 3) may be performed for positioning electric vehicle 152 (FIG. 4B) relative to charging station 102 (FIG. 4A), for pairing vehicle 152 to charging station 102 and for wireless energy transfer therebetween. Referring back to FIG. 3 and simultaneously to FIGS. 4A and 4B, in block 52, vehicle controller 178 of vehicle 152 may detect the presence of a radio signal (e.g. a far-field radio signal) emitted by radio 130 from one or more charging stations 102. Upon such detection and determining that the received radio signal is sufficiently strong (block 54), vehicle controller 178 may cause proximity transmitter controller 160 to cause proximity transmitter circuit 161 (e.g. near-field proximity transmitter circuit 161) to begin transmitting proximity signals (e.g. block 56 of the FIG. 3 method 50). The proximity transmitter circuit 161 used in block 56 may comprise a near-field communication transmitter (e.g. with electromagnetic wavelengths greater than the communication distance), such that communications from the near-field transmitter 161 are only discernable by the corresponding near-field communication receiver 111 in the closest charging station 102.

At block 56, proximity receiver circuit 111 receives (at proximity receiver controller 110) the proximity signals transmitted by proximity transmitter circuit 161 of vehicle 152. If the strength of the received proximity signals is below a configurable threshold value, then charging station controller 132 may cause display panel 122 to provide instructions to an operator of vehicle 152 (e.g. instructing the vehicle operator to drive closer to charging station 102). The instructions provided by display panel 122 may be purely visual, purely audio, or may comprise both audio and visual components. In some embodiments, where vehicle 152 comprises autonomous driving features, block 56 may comprise transmitting electronic instructions to the driving controller (not shown) of vehicle 152 to cause vehicle 152 to autonomously approach charging station 102.

When the strength of the received proximity signal exceeds a configurable threshold, indicating that vehicle 152 is adequately positioned relative to charging station 102 for MDC transmitter 104 to deliver wireless power to MDC receiver 154, display panel 122 may instruct the operator of vehicle 152 (or the controller of an autonomous vehicle 152) to stop.

In some embodiments, the received proximity signal may comprise a position measurement or some other indication representing a distance between vehicle 152 and charging station 102. More specifically, in some embodiments, the position measurement may represent the distance between MDC receiver 154 and MDC transmitter 104, from which the proximity signals are sent and received. According to a more specific embodiment, the distance between MDC receiver 154 and MDC transmitter 104 may be determined based on the distance from a midpoint of a line segment formed from the locations of proximity receiver coils 112A and 1126 and a midpoint of a line segment formed from the locations of proximity transmitter coils 162A and 1626.

Optionally, the received proximity signal may additionally comprises an alignment measurement representative of an offset between MDC receiver 154 and MDC transmitter 104. A non-limiting example of an alignment measurement is illustrated in FIG. 4C, where, based on the midpoints 112C, 162C of the line segments described above, the alignment measurement may represent the spatial (or positional) offset x and y between nominal alignment position 113 and midpoint 162C of the line segment formed by proximity transmitter coils 162A and 162B. These concepts are illustrated by FIG. 4C, where x and y represent example position measurements.

Referring back to FIG. 3, block 58 involves the performance of radio (wireless protocol) pairing between charging station 102 and vehicle 152. Charging station controller 132 may instruct MDC transmitter 104 to rotate its rotor 104A to generate a short burst (e,g, a pulse or step) of time-varying energy-transferring magnetic field. This burst of energy-transferring magnetic field may indicate that vehicle 152 has successfully docked. The burst of magnetic field causes the rotor 154A of a sufficiently proximate MDC receiver 154 to rotate. This rotation of rotor 154A may be detected by proximity transmitter controller 160 and/or vehicle controller 178. In turn, vehicle controller 178 and/or proximity transmitter controller 160 may cause proximity transmitter circuit 161 to transmit, to proximity receiver circuit 111, signals encoding a unique radio address of the wireless transceiver (radio) 176 of vehicle 152. The proximity transmitter circuit 161 used in block 58 may comprise a near-field communication transmitter, such that communications from the near-field transmitter 161 are only discernable by the corresponding near-field communication receiver 111 in the closest charging station 102.

The transmitted address may be received by proximity receiver circuit 111 and decoded by proximity receiver controller 110 and/or charging station controller 132 to obtain the radio address of the vehicle's radio 176. A suitable wireless communication link (e.g. pairing) may thereby be established between charging station 102 and electric vehicle 152 (specifically, between charging station radio 130 and vehicle radio 176).

At block 60 of the FIG. 3 method 50, wireless charging commences by MDC transmitter 104 producing a magnetic field through the rotation of its rotor 104A, which drives the rotation of rotor 154A of MDC receiver 154 to produce mechanical energy. The mechanical energy may be converted to electrical energy and stored in a battery 172A of vehicle 152 through the methods described herein. During charging, vehicle controller 178 may command proximity transmitter controller 160 to cause proximity transmitter circuit 161 to transmit monitoring signals to charging station 102 to monitor the position of vehicle 152 during the block 60 charging. Proximity receiver circuit 111 receives these monitoring signals and proximity receiver controller 110 may continuously report the position of vehicle 152 relative to charging station 102 to charging station controller 132.

It should be understood by a person of skill in the art that the proximity transmitter circuit 161 of vehicle 152 could be swapped with the proximity receiver circuit 111 of charging station 102. That is, charging station 102 could be provided with a suitably configured near-field proximity transmitter circuit and vehicle 152 could be provided with a suitably configured near-field receiver circuit. Swapping these components may involve corresponding changes to the communication steps described herein. For example, where vehicle 152 comprises a near-field receiver and charging station 102 comprises a near-field transmitter:
the charging station's near-field proximity transmitter may repeat the sequential transmission of a proximity signal followed by an address signal of its far-field radio transceiver 130. This sequential transmission pattern may be time division multiplexed and repeated. Each of these different sequential transmissions may be temporally spaced apart by a configurable time interval, so that one type of transmission can be discerned from the other—i.e. a proximity signal may be discerned temporally from an address signal.
the vehicle's near-field proximity receiver may receive the proximity signal and, in turn, the vehicle controller 178 may generate its own position instructions—that is, the proximity information is available at the vehicle and there is no need to communicate position instructions from the charging station to the vehicle or to the driver of the vehicle.
the vehicle's near-field proximity receiver may receive the address of the charging station's far-field radio transceiver 130 and the vehicle controller 188 may initiate the pairing process in response to receipt of this address—i.e. there is no need for the transmission of an energy pulse to initiate the address transmission sequence.
once pairing of the vehicle far-field radio 176 and the charging station far-field radio 130 is complete and the vehicle controller 178 determines (from the received proximity signal) that vehicle 152 is sufficiently close to the charging station 102, then vehicle controller 178 may communicate (via radio transceivers 176, 130) to charging station 102 that the vehicle is ready to receive energy and energy transfer may commence.

In addition or in the alternative to swapping the proximity transmitter circuit 161 of vehicle 152 with the proximity receiver circuit 111 of charging station 102, the near-field communication system between vehicle 152 and charging station 102 could, in some embodiments, comprise a duplex near-field communication system. This duplex communication scheme could be implemented in at least two ways. In some example embodiments, one of coils 112A, 112B of charging station 102 could be provided as a transmitter and the other of coils 112A, 112B of charging station 102 could be provided as a receiver. Similarly, one of coils 162A, 162B of vehicle 152 could be provided as a transmitter and the other of coils 162A, 162B of vehicle 152 could be provided as a receiver. In some other example embodiments, charging station 102 could be provided with some other form of near-field transceiver and vehicle 152 could be provided with some other form of near-field transceiver. It will be appreciated by those skilled in the art that such duplex near-field communication schemes may involve the use of other communication related hardware not expressly described herein.

Where the near-field communication systems of vehicle 152 and charging station 102 are capable of duplex communication, then some of the procedural steps described herein may be altered. For example:
the charging station 102 may output proximity signals (via its near-field transmitter/transceiver) to the vehicle 152 (via its near-field receiver/transceiver). Thus, the vehicle 152 may be aware of its proximity to the charging station and may output suitable position instructions either to its driver or to an autonomous driving controller.
once the vehicle controller 178 determines that the vehicle 152 is at a suitable location for energy transfer, the vehicle controller 178 may transmit the address of its far-filed radio 176 (via its near-field transmitter/transceiver) to the charging station 102 (via its near-field receiver/transceiver) to facilitate pairing. That is, there is no need for the transmission of an energy pulse to initiate the address transmission sequence.
once pairing of the vehicle far-field radio 176 and the charging station far-field radio 130 is complete, then either one of vehicle controller 178 or charging station controller 132 may communicate (via radio transceivers 176, 130) that the vehicle is ready to receive energy and energy transfer may commence.

Method 50 of FIG. 3 is described herein with reference to electric vehicle 152 of FIG. 4B (which incorporates a MDC wireless energy receiver 154) and charging station 102 of FIG. 4A (which incorporates a MDC wireless energy transmitter 104) without loss of generality. Those skilled in the art will appreciate that apart from the specifics of their wireless energy transmitter 204 and wireless energy receiver 254, the inductive charging station 202 of FIG. 5A and electric vehicle 252 of FIG. 5B are respectively similar to the FIG. 4A charging station 102 and the FIG. 4B electric vehicle 152 and that method 50 of FIG. 3 may be applicable to and/or performed by electric vehicle 252 of FIG. 5B and inductive charging station 202 of FIG. 5A. More specifically, with reference to the FIG. 5A charging station 202, components 202, 204, 204A, 206, 210, 211, 212A, 212B, 218, 220, 222, 224, 226, 228, 230, 232, 234 and 236 may perform similar or analogous functions to those of analogous components 102, 104, 104A, 106, 110, 111, 112A, 112B, 118, 120, 122, 124, 126, 128, 130, 132, 134 and 136 of the FIG. 4A charging station 102 and, with reference to the FIG. 5B vehicle 252, components 252, 254, 254A, 256, 260, 261, 262A, 262B, 268, 270, 272,272A, 272B, 274, 276, 278, 280, 282, 284, 286 and 288 may perform similar or analogous functions to those of analogous components 152, 154, 154A, 156, 160, 161, 162A, 162B, 168, 170, 172, 172A, 172B, 174, 176, 178, 180, 182, 184, 186 and 188 of the FIG. 4B vehicle 152. It will be appreciated that in the context of performing method 50, the specific method of energy transfer between inductive wireless energy transmitter 204 of inductive charging station 202 (FIG. 5A) and inductive wireless energy receiver 254 of electric vehicle 252 (FIG. 5B) may be different than that of wireless energy transmitter 104 and wireless energy receiver 154 described herein.

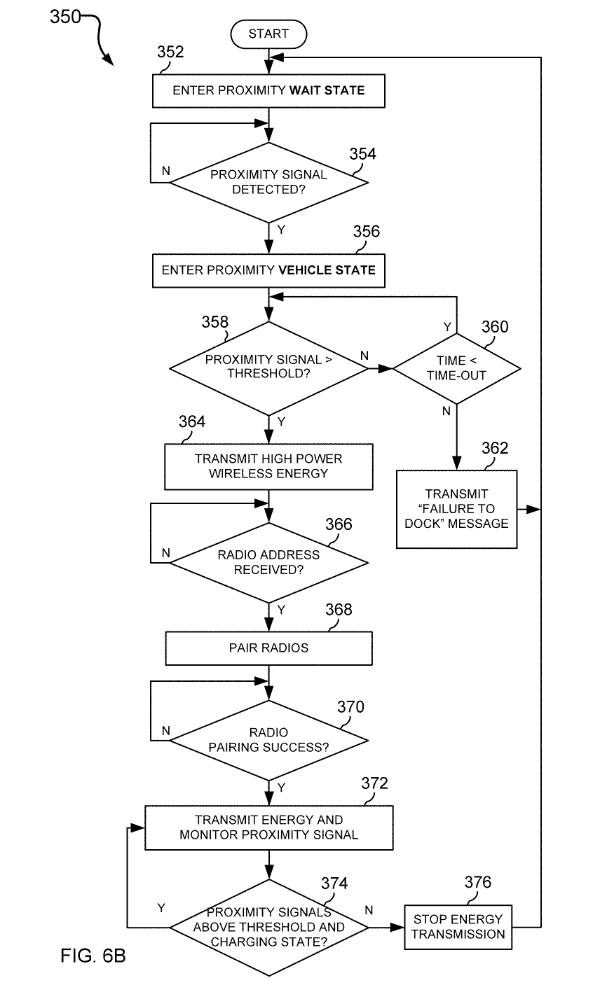

FIG. 6A illustrates an example method 300 which may be implemented by a vehicle controller (e.g. vehicle controller 178) on electric vehicle 152 to pair with a suitable wireless energy provider 102. At block 302, electric vehicle 152 approaches a wireless charging station 102. At block 304, method 300 comprises scanning for any available appropriate radio signals (e.g. far-field radio signals) emitted by a wireless charging station 102 within range. In some embodiments, the radio signal may be emitted by a Zigbee™ transceiver module (e.g. radio 130) of a wireless charging station 102. A Zigbee™ transceiver module (e.g. radio 176) of an electric vehicle 152 may scan for this emitted signal in the context of performing block 304. Once an appropriate radio signal is detected (block 304 YES branch), method 300 proceeds to block 306 to instruct proximity transmitter circuit (e.g. proximity transmitter circuit 161) on electric vehicle 152 to begin transmitting proximity signals. The proximity transmitter circuit 161 used in block 306 may comprise a near-field communication transmitter, such that communications from the near-field transmitter 161 are only discernable by the corresponding near-field communication receiver 111 in the closest charging station 102.

While possibly continuing to transmit proximity signals or possibly after transmission of proximity signals, method 300 commences pairing process 308, which involves proximity transmitter circuit 161 of vehicle 152 transmitting, to proximity receiver circuit 111, the address of the vehicle's far-field radio transceiver 176. The proximity transmitter circuit 161 used in block 308 may comprise a near-field communication transmitter, such that communications from the near-field transmitter are only discernable by the corresponding near-field communication receiver in the closest charging station. At decision block 310, method 300 searches for a burst (e.g. a pulse or step) of power transfer from charging station 102 to vehicle 152. In some embodiments, decision block 310 involves querying an operational parameter of a wireless power receiver 154 of the electric vehicle 152 and evaluating whether the operation parameter is operating above a configurable threshold value. This operational parameter may be correlated with the presence, or amount, of energy received by wireless power receiver 154. By way of non-limiting example, this operational parameter may be a rotational speed of rotor 154A of wireless energy receiver 154 or an energy output of wireless energy receiver 154 and/or the like. In embodiments where the wireless power receiver is an MDC receiver, the operational parameter may be the angular frequency of a rotor in the MDC receiver. In some embodiments, the threshold value may be an angular frequency of 5 Hz. If the operational parameter exceeds the threshold value, then method 300 proceeds to step 312, where proximity transmitter controller 161 enters an “Address State”, whereby proximity transmitter circuit 161 transmits a unique radio address of far-field radio transceiver 176 to charging station 102 (e.g. to proximity receiver circuit 111). After the block 312 transmission of the address of far-field radio transceiver 176 from proximity transmitter circuit 161 to proximity receiver circuit 111, the far-field radios (e.g. radio transceiver 130 of charging station 102 and radio transceiver 176 of vehicle 152) may take control of the pairing process. The pairing of far-field radio transceivers according to various far-field wireless protocols is known in the art.

At decision block 314, method 300 comprises waiting for a message from the wireless energy provider (e.g. charging station 102) to confirm the formation of a successful far-field communication link (e.g. a successful pairing between radio transceiver 130 of charging station 102 and radio transceiver 176 of vehicle 152). Such a message may be conveyed to vehicle controller 178 via radio transceiver 130 of charging station 102 and radio transceiver 176 of vehicle 152. If no such message is received within a threshold amount of time, or if radio 130 of charging station 102 outputs a “Failure to Dock” message (e.g. on display 122), method 300 may revert to step 306 to resume transmitting proximity signals and/or to instruct the driver to re-attempt docking. In some embodiments, method 300 reverts to step 306 after it has entered the “Address State” for 5 seconds and no message confirming the pairing is received in block 314. If a message indicating that a successful communication link (pairing) was formed is received in block 314, then method 300 comprises instructing the vehicle 152 to enter a charging state at step 316. Entering the charging state may comprise switching the electric vehicle 152 into an MDC charging mode and/or instructing the proximity transmitter circuit 161 to transmit proximity monitoring signals (as opposed to the block 312 address signals).

FIG. 6B illustrates an example method 350 which may be implemented by a controller (e.g. charging station controller 132) on a wireless energy provider, for example charging station 102, to pair with a suitable wireless power consumer, such as vehicle 152. At block 352, a wireless energy provider (e.g. charging station 102) is instructed to enter a “Wait State”, whereby it waits to detect near-field proximity signals received at a near-field proximity receiver circuit (e.g. proximity receiver circuit 111) on charging station 102. During the block 352 Wait State, far-field radio transceiver 130 may also intermittently transmit signals to let vehicles know of its existence—e.g. as part of block 52 (FIG. 3). If a near-field proximity signal is detected at decision block 354 (block 354 YES branch), charging station 102 enters a “Vehicle State” at block 356, whereby controller 132 of charging station 102 has determined that an electric vehicle 152 is approaching and, in response, instructs electric vehicle 152 or an operator of electric vehicle 152 to approach charging station 102.

At decision block 358, the strength of the proximity signals received at proximity receiver circuit 111 is compared to a configurable threshold value. If the received proximity signals do not exceed the threshold value after charging station 102 enters the “Vehicle State” within a configurable threshold (time-out) time at decision block 360 (block 260 NO branch), method 350 proceeds to block 362. In some embodiments, the time-out threshold time is 5 seconds, although other suitable thresholds are possible. At block 362, method 350 may comprise instructing charging station 102 to transmit a “Failure to Dock” message to electric vehicle 152 or to an operator of electric vehicle 152. In embodiments where charging station 102 comprises a display (e.g. display 122), the “Failure to Dock” message may be shown on the display. In some embodiments, the “Failure to Dock” message comprises corrective instructions for positioning and aligning the wireless power receiver (e.g. wireless power receiver 154) such that the proximity signals received by proximity receiver circuit 111 exceed the threshold value on subsequent docking attempts. For example, in some embodiments, the relative strengths of proximity signals detected at receiver coils 112A, 112B can be processed to provide corrective alignment information, which may, for example, be included with the “Failure to Dock” message to aid the operator of vehicle 152 with better alignment on a subsequent docking attempt. From block 362, method 350 may return to block 352, where method 350 restarts.

If, in decision block 358, the strength of the received proximity signal exceeds the threshold value (block 358 YES branch), then method 350 proceeds to block 364, where a burst, pulse or step of high power wireless energy is transmitted to electric vehicle 152 (e.g. from MDC wireless energy transmitter 104 of charging station 102 to MDC wireless energy receiver 154 of vehicle 152). As discussed elsewhere herein, when vehicle 152 receives the block 364 energy pulse, vehicle controller 178 causes its near-field proximity transmitter circuit 161 to transmit the address of the vehicle's far-field radio 176 to proximity receiver circuit 111 at charging station 102. At decision block 366, method 350 comprises waiting to receive the radio address transmitted by proximity transmitter circuit 161 of electric vehicle 152. Upon receiving the address of the vehicle's far-field radio 176, method 350 proceeds to block 368 which involves pairing the charging station far-field radio 130 with the far-field radio 176 of vehicle 152. The block 368 pairing may be performed by charging station controller 132 via far-field radios 130, 176.

Block 370 involves an inquiry into whether the block 368 radio pairing was successful. If the block 368 pairing was successful (block 370 YES branch), electric vehicle 152 is deemed to be successfully docked and paired and, at block 372, charging station 102 may cause MDC power transmitter 104 to begin transmitting energy. Also at block 372, the proximity receiver circuit 111 on charging station 102 may continue to receive proximity signals to ensure that electric vehicle 152 remains docked. At decision block 374, if the monitored proximity signals received by proximity receiver circuit 111 fall beneath a configurable threshold value or if a message is received indicating that electric vehicle 152 has exited a charging state, charging station 102 ceases transmitting energy at block 376 and re-enters the “Wait State” at block 352. In some embodiments, the threshold values for the received proximity signals at decision block 358 and decision block 374 may be the same.

Method 300 of FIG. 6A and method 350 of FIG. 6B are described herein with reference to electric vehicle 152 of FIG. 4B (which incorporates a MDC wireless energy receiver 154) and MDC charging station 102 of FIG. 4A (which incorporates a MDC wireless energy transmitter 104) without loss of generality. Those skilled in the art will appreciate that apart from the specifics of their wireless energy transmitter 204 and wireless energy receiver 254, the inductive charging station 202 of FIG. 5A and electric vehicle 252 of FIG. 5B are respectively similar to the FIG. 4A charging station 102 and the FIG. 4B electric vehicle 152 and that method 300 of FIG. 6A and method 350 of FIG. 6B may be applicable to and/or performed by electric vehicle 252 of FIG. 5B and inductive charging station 202 of FIG. 5A. More specifically, with reference to the FIG. 5A charging station 202, components 202, 204, 204A, 206, 210, 211, 212A, 212B, 218, 220, 222, 224, 226, 228, 230, 232, 234 and 236 may perform similar or analogous functions to those of analogous components 102, 104, 104A, 106, 110, 111, 112A, 112B, 118, 120, 122, 124, 126, 128, 130, 132, 134 and 136 of the FIG. 4A charging station 102 and, with reference to the FIG. 5B vehicle 252, components 252, 254, 254A, 256, 260, 261, 262A, 262B, 268, 270, 272,272A, 272B, 274, 276, 278, 280, 282, 284, 286 and 288 may perform similar or analogous functions to those of analogous components 152, 154, 154A, 156, 160, 161, 162A, 162B, 168, 170, 172, 172A, 172B, 174, 176, 178, 180, 182, 184, 186 and 188 of the FIG. 4B vehicle 152. It will be appreciated that in the context of performing method 300 of FIG. 6A and/or method 350 of FIG. 6B, the specific method of energy transfer between inductive wireless energy transmitter 204 of inductive charging station 202 (FIG. 5A) and inductive wireless energy receiver 254 of electric vehicle 252 (FIG. 5B) may be different than that of wireless energy transmitter 104 and wireless energy receiver 154 described herein.

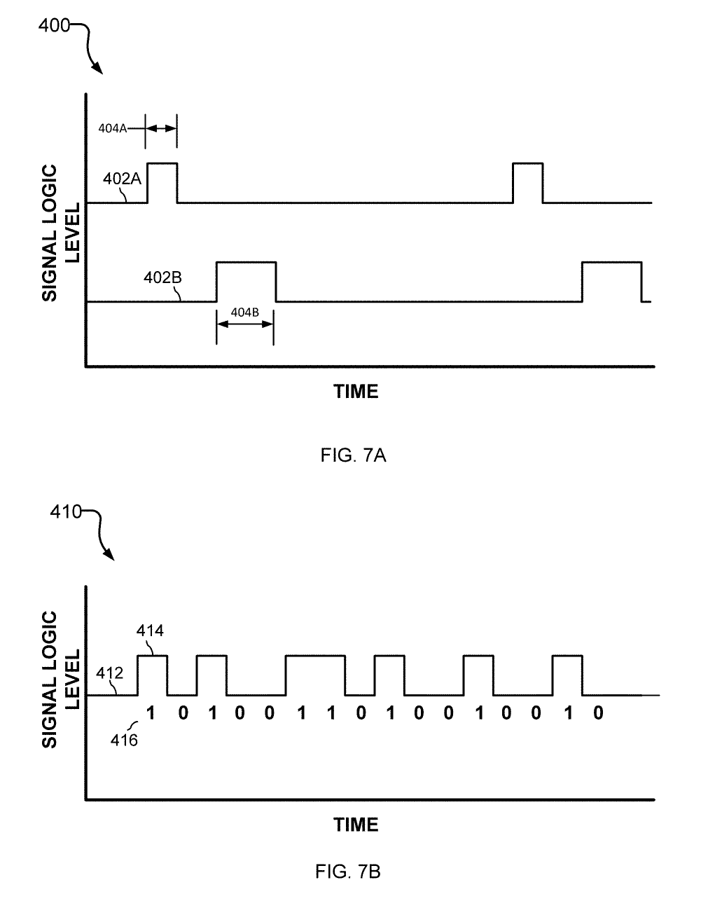

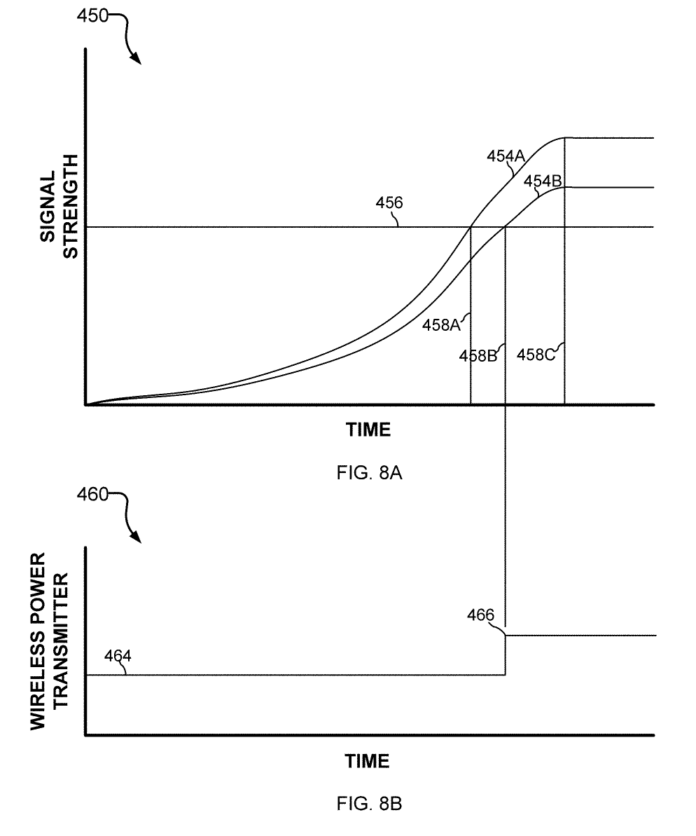

FIGS. 7A, 7B and 8A, 8B illustrate signalling logic and signal processing employed by an exemplary near-field proximity communication system according to a particular embodiment. The near-field proximity communication system comprises proximity transmitter coils (e.g. proximity transmitter coils 162A, 162B of MDC power receiver 154 of the FIG. 4B vehicle 152) which respectively generate proximity transmitter coil signals 402A and 402B (FIG. 7A), when operating in a proximity sensing mode (e.g. in block 56 of method 50 (FIG. 3) and/or in block 306 of method 300 (FIG. 6A). The near-field proximity communication system also comprises proximity receiver coils (e.g. proximity receiver coils 112A, 112B of MDC power transmitter 104 of the FIG. 4A charging station 102) which respectively generate proximity receiver coil signals 454A and 454B (FIG. 8A), when operating in the proximity sensing mode (e.g. in block 56 of method 50 (FIG. 3) and/or in block 356 of method 350 (FIG. 6B).

The FIG. 7A plot 400 shows signalling logic levels plotted against time for transmitter coil signals 402A and 402B. Plot 400 shows how coil signals 402A, 402B may be used to uniquely identify each coil, and, in some embodiments, may be used to assist with positioning vehicle 152 towards an optimal position and/or provide corrective information in the event of an unsuccessful docking attempt.

The pulse widths 404A and 404B represent passage of AC current through proximity transmitter coils 162A and 162B, respectively. This AC current results in the transmission of a proximity beacon signal which is detectable by the proximity receiver coils 112A, 112B which respectively generate proximity receiver coil signals 454A and 454B. As an illustrative example, a 125 kHz AC current may be passed through proximity receiver coils 112A, 112B for 5 ms and 10 ms, respectively. Pulse widths 404A and 404B may be different to allow the proximity receiver controller 110 to distinguish between proximity transmitter coils 162A and 162B.

In some embodiments, pulse widths 404A and 404B may be used to communicate vehicle specific information which may be used to optimize the positioning and alignment of various vehicles with a wireless charging station 102. In some embodiments, the communication of vehicle specific information facilitates vehicle and/or battery identification for metering and/or billing purposes. Communication of the vehicle-specific parameters may also enable the systems described herein to adjust operation based on the vehicle configuration to maximize the accuracy of the system for a multitude of factors (e.g. make, model, energy transfer parameters, calibration levels, energy receiver/transmitter mounting locations and/or the like).

FIG. 7B depicts signalling logic utilized by a proximity communication system for communicating an electric vehicle's radio address (e.g. the address of radio 176 of vehicle 152) to a charging system controller (e.g. charging system controller 132) to pair the vehicle's radio address with the charging system's radio address (e.g. the address of radio 130 of charging system 102) according to an exemplary embodiment—see block 58 of method 50 (FIG. 3) or block 312 of method 300 (FIG. 6A), for example. Plot 410 shows logic levels plotted against time illustrating an example method for encoding the address of vehicle radio 176. Signal 412 is an on/off modulated signal, whereby an example positive pulse 414 represents a signal produced by the passage of AC current through proximity transmitter coils 162A and 162B. A resulting digital bit stream 416 is transmitted, which may be received by proximity receiver coils 112A and 112B at wireless charging station 102 and decoded by wireless proximity receiver controller 110.

FIG. 8A depicts signal processing performed by proximity receiver circuit 111 in a wireless charging station (e.g. wireless charging station 102) according to an exemplary embodiment of a proximity communication system. In plot 450, analog signals 454A, 454B representative of received proximity signal strength at proximity receiver coils 112A and 112B are plotted against time, depicting a scenario where an electric vehicle approaches wireless charging station 102. Signals 454A and 454B are respectively representative of the strengths of the signals received at receiver coils 112A, 112B.

Signals 454A and 454B may be compared with a docking signal threshold 456 to determine whether a desired positioning and, in some embodiments, alignment between electric vehicle 152 and wireless charging station 102 has been achieved. Scenarios 458A, 458B and 458C illustrate three different operational scenarios for signals 454A and 454B with respect to docking threshold 456. Scenario 458A occurs when signal 454A is at or exceeds docking signal threshold 456, but signal 454B has not met threshold 456. Scenario 458A may indicate that the electric vehicle 152 is sufficiently close to one side of the wireless charging station 102 comprising proximity receiver coil 112A, but is not sufficiently close to another side of the wireless charging station 102 comprising proximity receiver coil 112B. Scenario 458B occurs when both signals 454A and 454B meet or exceed docking threshold 456. Scenario 458C may occur some time after scenario 458B occurs, when electric vehicle 152 stops moving and both signals 454A and 454B exceed threshold 456. Accordingly, signal levels of signals 454A and 454B remains constant thereafter.

It should be noted that in some embodiments or implementations, the vehicle 152 may be 100% aligned with charging station 102. In some embodiments or implementations, vehicle 152 may be substantially aligned with the charging station 102. In still some embodiments, vehicle 152 may be misaligned by 10-20% or as much as 40% while the charging still occurs.

FIG. 8B depicts signaling logic that may be utilized by a wireless power transmitter (e.g. wireless power transmitter 104 of charging station 102) in conjunction with the positioning and alignment of the electric vehicle 152 depicted in FIG. 8A during approach of a vehicle 152. The FIG. 8B plot 460 shows a control signal 464 for wireless power transmitter 104 against time. At time 466, which may coincide with proximity receiver signals 454A and 454B exceeding signal threshold 456, control signal 464 exhibits a step or pulse and operates at an elevated level. The signalling logic depicted in plot 460 may be employed, for example at block 364 of method 350 (FIG. 6B) for transmitting high power wireless energy to an electric vehicle 152 to thereby initiate or commence the radio pairing process between electric vehicle 152 and wireless charging station 102. In some embodiments, where the radio pairing process between electric vehicle 152 and wireless charging station 102 is unsuccessful, control signal 464 may return to an initial un-elevated level.

In some embodiments, signals 454A and 454B (FIG. 8A) may be converted to a position and alignment measurement, such as that illustrated in FIG. 4C. In such embodiments, the measurements may be compared against a plurality of threshold values. In some embodiments, the position measurement may be required to be below 0.5 m before time 466 in FIG. 8B occurs. In some embodiments, the alignment measurement (of x and y values) may be required to be below 5-20 cm before time 466 occurs. In other embodiments, the alignment measurement threshold may be 30 cm.

The techniques illustrated in FIGS. 7A, 7B, 8A, 8B are explained herein with reference to electric vehicle 152 of FIG. 4B (which incorporates a MDC wireless energy receiver 154) and MDC charging station 102 of FIG. 4A (which incorporates a MDC wireless energy transmitter 104) without loss of generality. Those skilled in the art will appreciate that apart from the specifics of their wireless energy transmitter 204 and wireless energy receiver 254, the inductive charging station 202 of FIG. 5A and electric vehicle 252 of FIG. 5B are respectively similar to the FIG. 4A charging station 102 and the FIG. 4B electric vehicle 152 and that the techniques illustrated in FIGS. 7A, 7B, 8A, 8B may be applicable to and/or performed by electric vehicle 252 of FIG. 5B and inductive charging station 202 of FIG. 5A. More specifically, with reference to the FIG. 5A charging station 202, components 202, 204, 204A, 206, 210, 211, 212A, 212B, 218, 220, 222, 224, 226, 228, 230, 232, 234 and 236 may perform similar or analogous functions to those of analogous components 102, 104, 104A, 106, 110, 111, 112A, 112B, 118, 120, 122, 124, 126, 128, 130, 132, 134 and 136 of the FIG. 4A charging station 102 and, with reference to the FIG. 5B vehicle 252, components 252, 254, 254A, 256, 260, 261, 262A, 262B, 268, 270, 272,272A, 272B, 274, 276, 278, 280, 282, 284, 286 and 288 may perform similar or analogous functions to those of analogous components 152, 154, 154A, 156, 160, 161, 162A, 162B, 168, 170, 172, 172A, 172B, 174, 176, 178, 180, 182, 184, 186 and 188 of the FIG. 4B vehicle 152. It will be appreciated that in the context of the techniques illustrated in FIGS. 7A, 7B, 8A, 8B, the specific method of energy transfer between inductive wireless energy transmitter 204 of inductive charging station 202 (FIG. 5A) and inductive wireless energy receiver 254 of electric vehicle 252 (FIG. 5B) may be different than that of wireless energy transmitter 104 and wireless energy receiver 154 described herein.

FIG. 9 is a more detailed schematic view of proximity receiver circuit 111 and proximity transmitter circuit 161 according to the embodiment illustrated in FIGS. 4A and 4B. Proximity transmitter controller 160 may comprise a microcontroller unit containing control components (e.g. suitable coded software together with suitable hardware circuitry) to generate control signals and drive AC current through first and second proximity transmitter coils 162A and 162B. According to a specific embodiment, proximity transmitter controller 160 comprises an Atmel ATMEGA328P microcontroller. In some embodiments, first proximity transmitter coil 162A may be located on the same circuit board as proximity transmitter controller 160. Second proximity transmitter coil 162B may be located separately and be connected to proximity transmitter controller 160 by proximity transmitter coil signal cable 164.

Proximity transmitter controller 160 may comprise any appropriate circuitry to supply AC current to proximity transmitter coils 162A and 162B. In some embodiments, proximity transmitter controller 160 comprises an H-Bridge constructed from MOSFETs. It will be apparent to those skilled in the art that various hardware schemes can be used to supply and regulate current to coils 162A and 162B, including, but not limited to, by making the coils part of a series or parallel-resonant tank circuit, and tuning said circuit (by the selection of components such as resistors, capacitors, inductors, and control signal frequency), such that a desirable amount of current flows through the coils 162A and 162B to generate proximity signals. Proximity transmitter controller 160 may communicate with vehicle controller 178 via proximity transmitter signal cable 168, using any suitable communications protocol such as RS-232, RS-485 or CANBUS.

Proximity receiver circuit 111 and/or proximity receiver controller 110 may comprise any appropriate circuitry for analog signal processing and/or analysis. In some embodiments, proximity receiver controller 110 comprises a peak voltage detection circuit (or some other strength detection circuit, which may be implemented in hardware and/or software), an analog to digital converter, and a suitably programmed processor, such as, for example, an Atmel ATMEGA328P microcontroller for processing signals and for performing signal analysis. In some embodiments, first proximity receiver coil 112A is located on the same circuit board as proximity receiver controller 110. Second proximity receiver coil 112B may be located separately and be connected to proximity receiver controller 110 by proximity receiver coil signal cable 114.

It will be apparent to those skilled in the art that various hardware and/or software schemes can be implemented to tune coils 112A and 112B to detect the strongest possible signals generated by transmitter coils 162A and 162B, including, but not limited to, by making the coils part of a series or parallel-resonant circuit, and tuning said circuit (by the selection of components such as resistors, capacitors, inductors). In some embodiments, signals received at proximity receiver coils 112A and 112B may be communicated to proximity receiver controller 110. In some embodiments, a signal received at proximity receiver controller 110 is passed into a peak voltage detection circuit or some other strength detection circuit, which may be implemented in hardware and/or software. According to a more specific embodiment, a signal representing the maximum signal amplitude is stored to allow for subsequent analog to digital conversion and/or signal analysis to occur.

The peak-detection approach described above is intended to only serve as an illustrative example, and alternate signal analysis schemes are possible. In some embodiments, a digital signal processor and digital filter is used in combination with the above peak voltage detection circuit. In other embodiments, a digital signal processor and digital filter may be used in place of the above peak voltage detection circuit. Proximity receiver controller 110 may communicate with charging station controller 132 via proximity receiver signal cable 118, using any suitable communications protocol such as RS-232, RS-485 or CANBUS.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the present invention include various operations, which are described herein. These operations may be performed by hardware components, software, firmware, or a combination thereof. For example, such methods or steps within such methods may be performed by suitably configured controllers (e.g. controllers 110, 132, 160, 178, 210, 232, 260, 278).

Certain embodiments may be implemented as a computer program product that may include instructions stored on a machine-readable medium. These instructions may be used to program a general-purpose or special-purpose processor to perform the described operations. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Computer processing components used in implementation of various embodiments of the invention (which may be referred to herein as “controllers” (e.g. controllers 110, 132, 160, 178, 210, 232, 260, 278)) may include one or more general-purpose processing devices such as a microprocessor or central processing unit, a controller, graphical processing unit (GPU), cell computer, or the like. Alternatively, such digital processing components may include one or more special-purpose processing devices such as a digital signal processor (DSP), an application specific integrated circuit (ASIC), a field programmable gate array (FPGA), or the like. In particular embodiments, for example, the digital processing device may be a network processor having multiple processors including a core unit and multiple microengines. Additionally, the digital processing device may include any combination of general-purpose processing device(s) and special-purpose processing device(s).

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments. In particular:
The proximity transmitter on the vehicle could encode additional vehicle-specific information into the beacon signals used during the proximity detection phase. This information could help the proximity receiver automatically identify the appropriate calibration levels for various vehicle makes & models and/or mounting locations.
Proximity transmitters and proximity receivers on the electric vehicle and charging station, respectively, could instead be proximity transceivers to enable two-way (duplex) communications.
A single proximity transmitter and a single proximity receiver could be located on each of the electric vehicle and charging station. This enables two-way (duplex) communications via two single-duplex communications paths (one from the vehicle to the charging station, and one from the charging station to the vehicle).
The charging station could be provided with a proximity transmitter and the vehicle could be provided with a proximity receiver as described elsewhere herein.
The proximity detection signal and address communication signal could be time-division multiplexed so they are transmitted continuously and sequentially. Such an implementation may permit both proximity detection and radio pairing to occur simultaneously. The near-field proximity transmitter may repeat the sequential transmission of a proximity signal followed by an address signal of its corresponding far-field radio transceiver. This sequential transmission pattern may be time division multiplexed and repeated. Each of these different sequential transmissions may be temporally spaced apart by a configurable time interval, so that one type of transmission can be discerned from the other—i.e. a proximity signal may be discerned temporally from an address signal.

1. A method for communication between a wireless charging station and a vehicle to facilitate wireless power transfer from a wireless power transmitter of the wireless charging station to a wireless power receiver of the vehicle, the method comprising:
providing a wireless charging station comprising a near-field proximity receiver circuit and a wireless power transmitter;
receiving, at the near-field proximity receiver circuit, a proximity signal sent wirelessly from a near-field proximity transmitter circuit of the vehicle;
while the received proximity signal is indicative of the vehicle being insufficiently proximate to the charging station for efficient power transfer, outputting instructions, in response to the received proximity signal, to move the vehicle to, by such movement, reduce a distance between the vehicle and the charging station; and
when the received proximity signal is indicative of the vehicle being sufficiently proximate to the charging station for efficient power transfer, wirelessly transmitting power from the wireless power transmitter of the charging station to the wireless power receiver of the vehicle.

2. The method of claim 1 comprising establishing a second wireless communication link between a wireless radio transceiver of the charging station and a wireless radio transceiver of the vehicle.

3. The method of claim 2 comprising receiving, at the near-field proximity receiver circuit, an address of the wireless radio transceiver of the vehicle, sent by the near-field proximity transmitter circuit of the vehicle.

4. The method of claim 3 comprising communicating between a controller of the charging station and a controller of the vehicle using the second wireless communication link during wireless transmission of power from the wireless power transmitter of the charging station to the wireless power receiver of the vehicle.

5. The method of claim 4 wherein establishing the second wireless communication link between the wireless radio transceiver of the charging station and the wireless radio transceiver of the vehicle occurs prior to wirelessly transmitting power from the wireless power transmitter of the charging station to the wireless power receiver.

6. The method of claim 3 comprising wirelessly transmitting a pulse of power from the wireless power transmitter of the charging station to the wireless power receiver prior to receiving, at the proximity receiver circuit, the address of the wireless radio transceiver of the vehicle, sent by the proximity transmitter circuit.

7. The method of claim 6 wherein wirelessly transmitting the pulse of power from the wireless power transmitter of the charging station to the wireless power receiver occurs in response to determining that the received proximity signal is indicative of the vehicle being sufficiently proximate to the charging station for efficient power transfer.

8. The method of claim 3 comprising, after receiving, at the proximity receiver circuit, the address of the wireless radio transceiver of the vehicle, sent by the proximity transmitter circuit, establishing a pairing between the wireless radio transceiver of the charging station and the wireless radio transceiver of the vehicle, to thereby establish the second wireless communication link.

9. The method of claim 1 comprising receiving, at the near-field proximity receiver circuit, the proximity signal sent wirelessly from the near-field proximity transmitter circuit of the vehicle during wireless transmission of power from the wireless power transmitter of the charging station to the wireless power receiver of the vehicle.

10. The method of claim 3 wherein:
receiving, at the proximity receiver circuit, the proximity signal sent wirelessly from the proximity transmitter circuit of the vehicle; and
receiving, at the proximity receiver circuit, the address of the wireless radio transceiver of the vehicle, sent wirelessly by the proximity transmitter circuit of the vehicle;
are time division multiplexed.

11. The method of claim 1 wherein outputting instructions, in response to the received proximity signal, to move the vehicle to, by such movement, reduce a distance between the vehicle and the charging station, comprises outputting instructions perceptible to a human operator of the vehicle.

12. The method of claim 3 wherein outputting instructions, in response to the received proximity signal, to move the vehicle to, by such movement, reduce a distance between the vehicle and the charging station comprises outputting instructions suitable for a driving controller of an autonomous vehicle.

13. The method of claim 12 wherein outputting instructions suitable for the driving controller of the autonomous vehicle comprises outputting instructions over the second wireless communication link.

14. The method of claim 2 wherein the second wireless communication link comprises a far-field wireless communication link.

15. The method of claim 2 wherein the wireless charging station comprises a near-field wireless transmitter and wherein the method comprises transmitting, from the near-field wireless transmitter to a near-field wireless receiver of the vehicle, an address of the wireless radio transceiver of the charging station.

16. The method of claim 15 wherein the near-field wireless transmitter and the near-field proximity receiver circuit of the charging station are integrated into a charging station transceiver.

17. The method of claim 15 wherein the near-field wireless transmitter and the near-field proximity receiver circuit of the charging station are separately embodied.

18. The method of claim 10 wherein outputting instructions, in response to the received proximity signal, to move the vehicle to, by such movement, reduce a distance between the vehicle and the charging station comprises outputting instructions suitable for a driving controller of an autonomous vehicle.

19. The method of claim 18 wherein outputting instructions suitable for the driving controller of the autonomous vehicle comprises outputting instructions over the second wireless communication link.

20. The method of claim 1 comprising determining when the received proximity signal is indicative of the vehicle being sufficiently proximate to the charging station for efficient power transfer by comparing a strength of the received proximity signal to a strength threshold.

21. A wireless charging station for wireless power transfer from the wireless charging station to a wireless power receiver of a vehicle, the wireless charging station comprising:
a near-field proximity receiver circuit;
a wireless power transmitter; and
a controller operatively connected to the near-field proximity receiver circuit and to the wireless power transmitter;
wherein the near-field receiver circuit is operative to receive a near-field proximity signal from a near-field proximity transmitter of a vehicle; and
wherein the controller is configured to:
while the received proximity signal is indicative of the vehicle being insufficiently proximate to the charging station for efficient power transfer, output instructions, in response to the received proximity signal, to move the vehicle to, by such movement, reduce a distance between the vehicle and the charging station; and
when the received proximity signal is indicative of the vehicle being sufficiently proximate to the charging station for efficient power transfer, wirelessly transmit power from the wireless power transmitter of the charging station to the wireless power receiver of the vehicle.
